(19) United States
(12) Patent Application Publication
(10) Pub. No.: US 2014/0121341 A1
(43) Pub. Date: May 1, 2014

(54) Supported Metallocene Catalyst Systems and Methods of Preparation Thereof

(71) Applicant: ExxonMobil Chemical Patents Inc., Baytown, TX (US)

(72) Inventors: Matthew W. Holtcamp, Huffman, TX (US); Gregory S. Day, Pasadena, TX (US); Celestino M. Perez, JR., Pasadena, TX (US); Garth R. Giesbrecht, The Woodlands, TX (US)

(21) Appl. No.: 14/064,585

(22) Filed: Oct. 28, 2013

Related U.S. Application Data
(60) Provisional application No. 61/720,555, filed on Oct. 31, 2012.

(51) Int. Cl. C08F 4/76; C08F 4/52

(52) U.S. Cl. CPC C08F 4/76; C08F 4/52
USPC 526/127; 502/104; 502/117

(57) ABSTRACT

This invention relates to a process to produce a supported metallocene catalyst system, the process comprising: (i) contacting a support material with an alkyl aluminum compound to provide an alkyl aluminum treated support material; wherein the alkyl aluminum compound is represented by the formula: R₃Al; wherein each R group is, independently, a substituted or unsubstituted C₁ to C₁₂ alkyl group, Cl or F with the proviso that at least one R group is a C₁ to C₁₂ alkyl group; (ii) contacting the alkyl aluminum treated support material with an ionic stoichiometric activator, wherein the ionic stoichiometric activator is represented by the formula: (Z)_{d}⁺A^{d-}; wherein (Z)_{d}⁺ is a cation, where Z is a reducible Lewis Acid, A^{d-} is a non-coordinating anion having the charge d−, and d is 1, 2, or 3; (iii) contacting a metallocene compound comprising a group 4, 5, or 6 metal with the alkyl aluminum treated support material; and (iv) obtaining a supported metallocene catalyst system.

### PRIORITY

This application claims priority to and the benefit of U.S. Provisional Application No. 61/720,555, filed Oct. 31, 2012, the disclosure of which is incorporated herein by reference in its entirety.

### FIELD OF THE INVENTION

This invention relates to supported metallocene catalyst systems, in particular supported metallocene systems useful for the production of polyolefins, in particular polypropylene and impact copolymers.

### BACKGROUND OF THE INVENTION

The use of metallocene compounds and catalyst systems in olefin polymerization is well known. Bridged, substituted indenyl metallocene compounds are noted for their ability to produce isotactic propylene polymers having high isotacticity and narrow molecular weight distribution. Considerable effort has been made toward obtaining metallocene produced propylene polymers having even higher molecular weight and melting point and, thus, even better strength (impact) properties, while maintaining suitable catalyst activity.

Toward this end, researchers have found that there is often a relationship between the way in which a metallocene is substituted and the molecular structure of the resulting polymer. For the bridged, substituted indenyl metallocene compounds, it is thought that the type and arrangement of substituents on the indenyl groups, as well as the type of bridge connecting the indenyl groups, influence such polymer attributes as molecular weight and melting point.

For example, U.S. Pat. Nos. 5,840,644 and 5,770,753 describe certain metallocenes containing aryl-substituted indenyl derivatives as ligands, which are said to provide propylene polymers having high isotacticity, narrow molecular weight distribution, and very high molecular weight.

Likewise, U.S. Pat. No. 5,936,053 describes certain metallocene compounds said to be useful for producing high molecular weight propylene polymers. These metallocenes have a specific hydrocarbon substituent at the 2 position and an unsubstituted aryl substituent at the 4 position on each indenyl group of the metallocene compound.

U.S. Pat. No. 7,122,498 discloses metallocene compounds which, in combination with a cocatalyst, make both propylene homopolymers having high melting points and elastomeric copolymers. These metallocenes are therefore useful for the production of impact copolymers in combination with propylene homopolymers.

WO 98/40419 and WO 99/42497 both describe certain supported catalyst systems for producing propylene polymers having high melting points.

Much of the current research in this area has been directed toward using metallocene catalyst systems under commercially relevant process conditions, to obtain propylene polymers having melting points higher than known metallocene catalyst systems and close to, or as high as, propylene polymers obtained using conventional Ziegler-Natta catalyst systems. Metallocene compositions and their activators are often combined with a support material in order to obtain a catalyst system that is less likely to cause reactor fouling.

U.S. Pat. No. 7,385,015 describes a process to prepare a trialkyl aluminum treated support comprising: 1) combining a support with first trialkyl aluminum compound(s), where the alkyl groups have at least 2 carbon atoms; then 2) calcining the combination of the support and the trialkyl aluminum compound(s); then 3) combining the calcined support with second trialkyl aluminum compound(s), where the alkyl groups have at least 2 carbon atoms; where the first and the second trialkyl aluminum compound(s) may be the same or different. The invention further relates to catalyst systems comprising catalyst compounds (such as bulky metallocenes) and such supports, as well as processes to polymerize unsaturated monomers using these catalyst systems.

Other references of interest include U.S. Provisional Application No. 61/720,560, filed Oct. 31, 2012.

However, it has been observed that supported metallocene catalyst systems tend to result in a polymer having lower melting point than would otherwise be obtained if the metallocene were not supported, and may often be significantly less active than if the metallocene were not supported. Accordingly, it would be desirable to have supported metallocene catalyst systems which afford propylene homopolymers having high melting points (and/or high stereotacticity). Additionally, it would be even more desirable to have the same supported metallocene catalyst systems provide elastomeric copolymers. These supported metallocene catalyst systems would therefore useful for the production of propylene-based in-reactor compositions such as impact copolymers.

### SUMMARY OF THE INVENTION

This invention relates to a process to produce a supported metallocene catalyst system, the process comprising: (i) contacting a support material with an alkyl aluminum compound to provide an alkyl aluminum treated support material, wherein the alkyl aluminum compound is represented by the formula: R₃Al, wherein each R group is, independently, a substituted or unsubstituted C₁ to C₁₂ alkyl group, Cl or F with the proviso that at least one R group is a C₁ to C₁₂ alkyl group; (ii) contacting the alkyl aluminum treated support material with an ionic stoichiometric activator, wherein the ionic stoichiometric activator is represented by the formula: (Z)_{d}⁺A^{d-}, wherein (Z)_{d}⁺ is a cation, where Z is a reducible Lewis Acid, A^{d-} is a non-coordinating anion having the charge d−, and d is 1, 2, or 3; (iii) contacting a metallocene compound comprising a group 4, 5, or 6 metal with the alkyl aluminum treated support material; and (iv) obtaining a supported metallocene catalyst system.

This invention also relates to a supported metallocene catalyst system comprising: (i) an alkyl aluminum treated support material, wherein the alkyl aluminum treated support material is the reaction product of a support material and an alkyl aluminum; wherein the support material is selected from the group consisting of SiO₂, Al₂O₃, or SiO₂/Al₂O₃, and wherein the alkyl aluminum is represented by the formula: R₃Al, wherein each R group is, independently, a substituted or unsubstituted C₁ to C₁₂ alkyl group, Cl or F with the proviso that at least one R group is a C₁ to C₁₂ alkyl group; (ii) an ionic stoichiometric activator, wherein the ionic stoichiometric activator is represented by the formula: (Z)_{d}⁺A^{d-}, wherein (Z)_{d}⁺ is a cation, where Z is a reducible Lewis Acid, and A^{d-} is a non-coordinating anion having the charge d−, and d is 1, 2, or 3; and (iii) a metallocene compound represented by the formula:

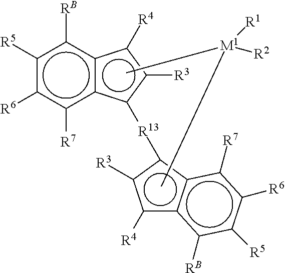

wherein:
M¹ is selected from titanium, zirconium, hafnium, vanadium, niobium, tantalum, chromium, molybdenum, and tungsten;
R¹ and R² are selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and substituted or unsubstituted C₇ to C₄₀ arylalkenyl groups; optionally R¹ and R² are joined together to form a C₄ to C₄₀ alkanediyl group or a conjugated C₄ to C₄₀ diene ligand which is coordinated to M¹ in a metallacyclopentene fashion; optionally, R¹ and R² represent a conjugated diene, optionally, substituted with one or more groups independently selected from hydrocarbyl, trihydrocarbylsilyl, and trihydrocarbylsilylhydrocarbyl groups, said diene having a total of up to 40 atoms not counting hydrogen and forming a π complex with M¹;
each R³ and R^{B} is independently selected from hydrogen, halogen, substituted or unsubstituted C₁ to C₁₀ alkyl groups, substituted or unsubstituted C₆ to C₁₄ aryl groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups, substituted or unsubstituted C₈ to C₄₀ arylalkenyl groups, and —NR′₂, —SR′, —OR′, —SiR′₃, —OSiR′₃, and —PR′₂ radicals wherein each R′ is independently selected from halogen, substituted or unsubstituted C₁ to C₁₀ alkyl groups and substituted or unsubstituted C₆ to C₁₄ aryl groups;
R⁴, R⁵, R⁶, and R⁷ are each selected from the group consisting of hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and C₇ to C₄₀ substituted or unsubstituted arylalkenyl groups; and
R¹³ is selected from:

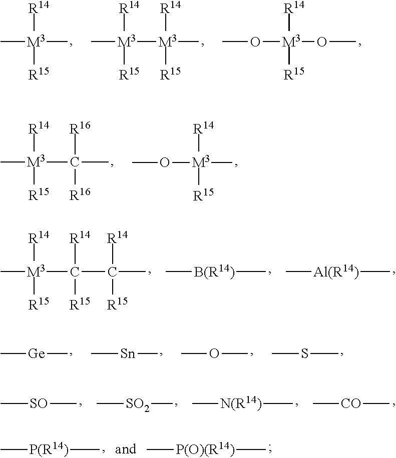

wherein:
R¹⁴, R¹⁵, and R¹⁶ are each independently selected from hydrogen, halogen, C₁ to C₂₀ alkyl groups, C₆ to C₃₀ aryl groups, C₁ to C₂₀ alkoxy groups, C₂ to C₂₀ alkenyl groups, C₇ to C₄₀ arylalkyl groups, C₈ to C₄₀ arylalkenyl groups, and C₇ to C₄₀ alkylaryl groups, optionally, R¹⁴ and R¹⁵, together with the atom(s) connecting them, form a ring; and
M³ is selected from carbon, silicon, germanium and tin; or
R¹³ is represented by the formula:

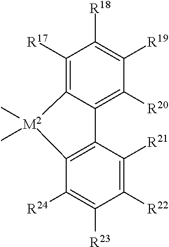

wherein:
R¹⁷, R¹⁸, R¹⁹, R²⁰, R²¹, R²², R²³, and R²⁴ are each independently selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ alkylaryl groups, substituted or unsubstituted C₇ to C₄₀ alkylaryl groups and substituted or unsubstituted C₈ to C₄₀ arylalkenyl groups; optionally two or more adjacent radicals R¹⁷, R¹⁸, R¹⁹, R²⁰, R²¹, R²², R²³, and R²⁴, including R²⁰ and R²¹, together with the atoms connecting them, form one or more rings; and
M² represents one or more carbon atoms, or a silicon, germanium or tin atom.

This invention also relates to a polymerization process comprising: (i) contacting a support material with an alkyl aluminum compound to provide an alkyl aluminum treated support material, wherein the alkyl aluminum compound is represented by the formula: R₃Al; wherein each R group is, independently, a substituted or unsubstituted C₁ to C₁₂ alkyl group, Cl or F, with the proviso that at least one R group is a C₁ to C₁₂ alkyl group; (ii) contacting a metallocene compound comprising a group 4, 5, or 6 metal with the alkyl aluminum treated support material of step (i); (iii) contacting an ionic stoichiometric activator with the alkyl aluminum treated support material of step (i), wherein the ionic stoichiometric activator is represented by the formula: (Z)_{d}⁺A^{d-}, wherein (Z)_{d}⁺ is a cation, where Z is a reducible Lewis Acid, A^{d-} is a non-coordinating anion having the charge d−, and d is 1, 2, or 3; (iv) obtaining a supported metallocene catalyst system; (v) contacting one or more C₂ to C₄₀ olefin monomers with the supported metallocene catalyst system under polymerization conditions; and (vi) obtaining a polyolefin.

### DETAILED DESCRIPTION

The inventors have surprisingly found a new supported metallocene catalyst system useful in olefin polymerization, in particular, propylene and/or ethylene polymerization. Indeed, these new supported metallocene catalyst systems produce high melting point isotactic polypropylene. The inventors found that combining an ionic stoichiometric activator (such as [(C₆H₅)₃C⁺][⁻B(C₆F₅)₄]) and a metallocene compound (such as with rac-Me₂Si(2-methyl-4-phenyl-1-indenyl)₂ZrMe₂) with trialkyl aluminum treated silica (for example, trimethyl aluminum treated silica) yielded a supported metallocene catalyst system which proved highly active for propylene polymerization. Additionally, the polypropylene produced using these supported metallocene catalyst systems proved to have melting points of 153° C. or greater.

Typically, supported metallocene compounds activated by alumoxanes (such as methyl alumoxane, MAO) tend to make less crystalline polypropylene than their unsupported analogs. This loss in crystallinity is often reflected by a significant decrease in melting point. The inventors herein provide a new supported metallocene catalyst system that produces polyolefins, in particular high melting point polypropylene, processes to produce such supported metallocene catalyst systems, polymerization processes using these supported metallocene catalyst systems, and polyolefins produced via these polymerization processes.

### DEFINITIONS

For the purposes of this invention and the claims thereto, the new numbering scheme for the Periodic Table Groups is used as set out in CHEMICAL AND ENGINEERING NEWS, 63(5), pg. 27 (1985). Therefore, a “group 4 metal” is an element from group 4 of the Periodic Table.

An “olefin,” alternatively referred to as “alkene,” is a linear, branched, or cyclic compound of carbon and hydrogen having at least one double bond. For the purposes of this invention and the claims thereto, when a polymer is referred to as “comprising an olefin,” the olefin present in the polymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer.

A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different,” as used to refer to mer units, indicates that the mer units differ from each other by at least one atom or are different isomerically. Accordingly, the definition of copolymer, as used herein, includes terpolymers and the like.

An “ethylene polymer” or “ethylene copolymer” is a polymer or copolymer comprising at least 50 mol % ethylene derived units, a “propylene polymer” or “propylene copolymer” is a polymer or copolymer comprising at least 50 mol % propylene derived units, and so on.

For the purposes of this invention and the claims thereto, ethylene shall be considered an α-olefin.

For the purposes of this invention and the claims thereto, when catalyst systems are described as comprising neutral stable forms of the components, it is well understood by one of ordinary skill in the art, that the ionic form of the component is the form that reacts with the monomers to produce polymers.

In the description herein, the metallocene compound may be described as a catalyst precursor, a pre-catalyst compound, a catalyst compound, a metallocene catalyst compound, or a transition metal compound, and these terms are used interchangeably.

A polymerization catalyst system is a catalyst system that can polymerize monomers to polymer and comprises a metallocene catalyst compound, an activator, and a support.

A metallocene compound is defined as an organometallic compound with at least one π-bound cyclopentadienyl moiety (or substituted cyclopentadienyl moiety) and more frequently two π-bound cyclopentadienyl moieties or substituted cyclopentadienyl moieties.

For purposes of this invention and claims thereto, in relation to metallocene compounds, the term “substituted” means that a hydrogen group has been replaced with a hydrocarbyl group, a heteroatom, or a heteroatom containing group. For example, methyl cyclopentadiene (Cp) is a Cp group substituted with a methyl group. Accordingly, indene and fluorene are considered substituted cyclopentadienyl moieties.

Otherwise, the term “substituted” means that a hydrogen group has been replaced with a heteroatom or a heteroatom containing group. For example, a “substituted hydrocarbyl” is a radical made of carbon and hydrogen where at least one hydrogen is replaced by a heteroatom or heteroatom containing group.

For purposes of this invention and claims thereto, “alkoxides” include those where the alkyl group is a C₁ to C₁₀ hydrocarbyl. The alkyl group may be straight chain, branched, or cyclic. The alkyl group may be saturated or unsaturated. In some embodiments, the alkyl group may comprise at least one aromatic group.

“Catalyst productivity” is a measure of how many grams of polymer (P) are produced using a polymerization catalyst comprising W g of catalyst (cat), over a period of time of T hours, and may be expressed by the following formula: P/(T×W) and expressed in units of gpolymer/g(cat)/hr. “Catalyst activity” is a measure of how many grams of polymer of polymer are produced using a polymerization catalyst comprising W g of catalyst (cat) and may be expressed by the following formula: P/W, expressed in units of gP/g(cat), and is typically used for batch processes. Catalyst activity may be converted to catalyst productivity by taking into account the run time of the batch process: catalyst productivity=catalyst activity/T, where T is the run time in hours.

As used herein, Mn is number average molecular weight, Mw is weight average molecular weight, and Mz is z average molecular weight, wt % is weight percent, and mol % is mole percent. Molecular weight distribution (MWD), also referred to as polydispersity, is defined to be Mw divided by Mn. Unless otherwise noted, all molecular weight units (e.g., Mw, Mn, Mz) are g/mol. The following abbreviations may be used herein: Me is methyl, Et is ethyl, Pr is propyl, cPr is cyclopropyl, nPr is n-propyl, iPr is isopropyl, Bu is butyl, nBu is normal butyl, iBu is isobutyl, sBu is sec-butyl, tBu is tert-butyl, Oct is octyl, Ph is phenyl, Bn is benzyl, and MAO is methylalumoxane.

### Processes to Produce a Supported Metallocene Catalyst System

Embodiments of this invention relate to processes to produce a supported metallocene catalyst system, the process comprising: (i) contacting a support material with an alkyl aluminum compound to provide an alkyl aluminum treated support material, wherein the alkyl aluminum compound is represented by the formula: R₃Al; wherein each R group is, independently, a substituted or unsubstituted C₁ to C₁₂ alkyl group, Cl or F with the proviso that at least one R group is a C₁ to C₁₂ alkyl group; (ii) contacting the alkyl aluminum treated support material with an ionic stoichiometric activator, wherein the ionic stoichiometric activator is represented by the formula: (Z)_{d}⁺A^{d-}, wherein (Z)_{d}⁺ is a cation, where Z is a reducible Lewis Acid, A^{d-} is a non-coordinating anion having the charge d−, and d is 1, 2, or 3; (iii) contacting a metallocene compound comprising a group 4, 5, or 6 metal with the alkyl aluminum treated support material; and (iv) obtaining a supported metallocene catalyst system.

### Alkyl Aluminum Treated Support Materials

In embodiments of this invention, the process comprises contacting a support material (preferably a calcined support material), further described below, with an alkyl aluminum compound to provide an alkyl aluminum treated support material, wherein the alkyl aluminum compound is represented by the formula: R₃Al; wherein each R group is, independently, a substituted or unsubstituted C₁ to C₁₂ alkyl group, Cl or F with the proviso that at least one R group is a C₁ to C₁₂ alkyl group.

Alkyl aluminum compounds which may be utilized include, for example, one or more of trimethyl aluminum, triethyl aluminum, tri-n-octyl aluminum, tri-isobutyl aluminum, tri-n-hexyl aluminum, and dimethyl aluminum fluoride. It is within the scope of this invention to use more than one alkyl aluminum compound to provide the alkyl aluminum treated support.

In some embodiments of this invention, the support material, typically having reactive surface groups, typically hydroxyl groups, is slurried in a non-polar solvent and the resulting slurry is contacted with a solution of an alkyl aluminum compound (for example, triethyl aluminum). The slurry mixture may be heated to about 0° C. to about 100° C., preferably to about 25° C. to about 85° C., preferably at room temperature. Room temperature is 23° C. unless otherwise noted. Contact times typically range from about 0.5 hours to about 24 hours, from about 2 hours to about 16 hours, or from about 4 hours to about 8 hours.

Suitable non-polar solvents are materials in which all of the reagents used herein, i.e., the alkyl aluminum compound and the metallocene compound, are at least partially soluble and which are liquid at reaction temperatures. Preferred non-polar solvents are alkanes, such as isopentane, hexane, n-heptane, octane, nonane, and decane, although a variety of other materials including cycloalkanes, such as cyclohexane, aromatics, such as benzene, toluene, and ethylbenzene, alone or in combination, may also be employed.

In embodiments of the invention herein, the support material is contacted with a solution of an alkyl aluminum compound to form an alkyl aluminum treated support material. The period of time for contact between the alkyl aluminum and the support material is as long as is necessary to passivate the reactive groups on the support material. To “passivate” means to react with available reactive groups on the surface of the support material, thereby reducing the surface hydroxyl groups by at least 80%, at least 90%, at least 95%, or at least 98%. The surface reactive group concentration may be determined based on the calcining temperature and the type of support material used. The support material calcining temperature affects the number of surface reactive groups on the support material available to react with the metallocene compound and an alkyl aluminum compound: the higher the drying temperature, the lower the number of sites. For example, where the support material is silica which, prior to the use thereof in the first catalyst system synthesis step, is dehydrated by fluidizing it with nitrogen and heating at about 600° C. for about 16 hours, a surface hydroxyl group concentration of about 0.5 to about 0.9 millimoles per gram, preferably about 0.6 to about 0.9 millimoles per gram, preferably about 0.6 to about 0.8 millimoles per gram, is typically achieved. Thus, the exact molar ratio of the alkyl aluminum compound to the surface reactive groups on the carrier will vary.

The amount of the alkyl aluminum compound which will be deposited onto the support material in the solution can be determined in any conventional manner, e.g., by adding the alkyl aluminum compound to the slurry of the carrier in the solvent, while stirring the slurry, until the alkyl aluminum compound is detected as a solution in the solvent by any technique known in the art, such as by ¹H NMR (in the event of conflict in the techniques, ¹H NMR shall be used). For example, for the silica support material heated at about 600° C., the amount of the alkyl aluminum compound added to the slurry is such that the molar ratio of Al to the hydroxyl groups (OH) on the silica is about 0.5:1 to about 4:1, preferably about 0.8:1 to about 3:1, more preferably about 0.9:1 to about 2:1, and most preferably about 1:1. The amount of Al in/on the silica may be determined by using ICPES (Inductively Coupled Plasma Emission Spectrometry), which is described in J. W. Olesik, “Inductively Coupled Plasma-Optical Emission Spectroscopy,” in the Encyclopedia of Materials Characterization, C. R. Brundle, C. A. Evans, Jr. and S. Wilson, eds., Butterworth-Heinemann, Boston, Mass., 1992, pp. 633-644. In another embodiment, it is also possible to add such an amount of the alkyl aluminum compound which is in excess of that which will be deposited onto the support material, and then remove the excess, e.g., by filtration and washing.

### Producing the Supported Metallocene Catalyst System

Preferably, the alkyl aluminum treated support is then contacted with an ionic stoichiometric activator, wherein the ionic stoichiometric activator is represented by the formula: (Z)_{d}⁺A^{d-}, wherein (Z)_{d}⁺ is a cation, where Z is a reducible Lewis Acid, A^{d-} is a non-coordinating anion having the charge d−, and d is 1, 2, or 3; and also contacted with a metallocene compound comprising a group 4, 5, or 6 metal with the alkyl aluminum treated support material. The contacting of the alkyl aluminum treated support with the ionic stoichiometric activator and the metallocene compound may occur sequentially, in any order, or may occur simultaneously.

Preferably, the alkyl aluminum treated support is slurried into an appropriate solvent, preferably a non-polar solvent. Preferred non-polar solvents are alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

The metallocene compound and the ionic stoichiometric activator are added, either sequentially, or together, to the slurry mixture and heated to a temperature in the range of from 0° C. to about 100° C., preferably from about 25° C. to about 85° C., most preferably at about 25° C. Contact times typically range from about 0.5 hours to about 24 hours, from about 2 hours to about 16 hours, or from about 4 hours to about 8 hours. The volatiles are removed to yield the supported metallocene catalyst system, preferably as a free-flowing solid. Each of the support material, ionic stoichiometric activator, and the metallocene compound are further discussed below.

### Support Materials

In embodiments herein, the catalyst system comprises an inert support material. Preferably, the supported material is a porous support material, for example, talc and inorganic oxides. Other support materials include zeolites, clays, organoclays, or any other organic or inorganic support material, and the like, or mixtures thereof.

Preferably, the support material is an inorganic oxide in a finely divided form. Suitable inorganic oxide materials for use in metallocene catalyst systems herein include Groups 2, 4, 13, and 14 metal oxides such as silica, alumina, and mixtures thereof. Other inorganic oxides that may be employed, either alone or in combination, with the silica or alumina are magnesia, titania, zirconia, and the like. Other suitable support materials, however, can be employed, for example, finely divided functionalized polyolefins such as finely divided polyethylene. Particularly useful supports include magnesia, titania, zirconia, montmorillonite, phyllosilicate, zeolites, talc, clays, and the like. Also, combinations of these support materials may be used, for example, silica-chromium, silica-alumina, silica-titania, and the like. Preferred support materials include Al₂O₃, ZrO₂, SiO₂, and combinations thereof, more preferably SiO₂, Al₂O₃, or SiO₂/Al₂O₃.

It is preferred that the support material, most preferably an inorganic oxide, has a surface area in the range of from about 10 m²/g to about 700 m²/g, pore volume in the range of from about 0.1 cc/g to about 4.0 cc/g, and average particle size in the range of from about 5 μm to about 500 μm. More preferably, the surface area of the support material is in the range of from about 50 m²/g to about 500 m²/g, pore volume of from about 0.5 cc/g to about 3.5 cc/g, and average particle size of from about 10 μm to about 200 μm. Most preferably, the surface area of the support material is in the range is from about 100 m²/g to about 400 m²/g, pore volume from about 0.8 cc/g to about 3.0 cc/g, and average particle size is from about 5 μm to about 100 μm. The average pore size of the support material useful in the invention is in the range of from about 10 Å to about 1000 Å, preferably about 50 Å to about 500 Å, and most preferably about 75 Å to about 350 Å. In some embodiments, the support material is a high surface area, amorphous silica (surface area=300 m²/gm, pore volume of 1.65 cm³/gm), and is marketed under the tradenames of DAVISON 952 or DAVISON 955 by the Davison Chemical Division of W. R. Grace and Company. In other embodiments, DAVIDSON 948 is used.

In some embodiments of this invention, the process may further comprise calcining the support material at a temperature in the range of from about 100° C. to about 1000° C. prior to contacting with the alkyl aluminum compound in step (i). Drying of the support material can be achieved by heating or calcining at about 100° C. to about 1000° C., preferably at about 200° C. to 850° C., preferably at least about 600° C. (preferably, the support material is calcined to a temperature of from about 550° C. to about 650° C.). When the support material is silica, it is typically heated to at least 200° C., preferably about 100° C. to about 1000° C., preferably about 200° C. to about 850° C., and most preferably at least about 600° C.; and for a time of about 1 minute to about 100 hours, from about 12 hours to about 72 hours, or from about 24 hours to about 60 hours.

### Ionic Stoichiometric Activators

Ionic stoichiometric activators may contain an active proton, or some other cation associated with, but not coordinated to, or only loosely coordinated to, the remaining anion of the activator. Such compounds and the like are described in European publications EP 0 570 982 A; EP 0 520 732 A; EP 0 495 375 A; EP 0 500 944 B1; EP 0 277 003 A; EP 0 277 004 A; U.S. Pat. Nos. 5,153,157; 5,198,401; 5,066,741; 5,206,197; 5,241,025; 5,384,299; 5,502,124; and U.S. patent application Ser. No. 08/285,380, filed Aug. 3, 1994; all of which are herein fully incorporated by reference.

Ionic stoichiometric activators comprise a cation, which is preferably a Bronsted acid capable of donating a proton, and a compatible non-coordinating anion. Preferably, the anion is relatively large (bulky), capable of stabilizing the catalytically active species (preferably a group 4 catalytically active species) which is formed when the metallocene compound and the stoichiometric activator are combined. Preferably, the anion will be sufficiently labile to be displaced by olefinic, diolefinic and acetylenically unsaturated substrates or other neutral Lewis bases, such as ethers, amines, and the like. Two classes of compatible non-coordinating anions have been disclosed in EP 0 277,003 A and EP 0 277,004 A: 1) anionic coordination complexes comprising a plurality of lipophilic radicals covalently coordinated to and shielding a central charge-bearing metal or metalloid core, and 2) anions comprising a plurality of boron atoms, such as carboranes, metallacarboranes, and boranes.

Ionic stoichiometric activators comprise an anion, preferably a non-coordinating anion. The term “non-coordinating anion” (NCA) means an anion which either does not coordinate to said cation or which is only weakly coordinated to said cation thereby remaining sufficiently labile to be displaced by a neutral Lewis base. “Compatible” non-coordinating anions are those which are not degraded to neutrality when the initially formed complex decomposes. Further, the anion will not transfer an anionic substituent or fragment to the cation so as to cause it to form a neutral four coordinate metallocene compound and a neutral by-product from the anion. Non-coordinating anions useful in accordance with this invention are those that are compatible, stabilize the metallocene cation in the sense of balancing its ionic charge at +1, yet retain sufficient lability to permit displacement by an ethylenically or acetylenically unsaturated monomer during polymerization.

In a preferred embodiment of this invention, the ionic stoichiometric activators are represented by the following formula (1):

(Z)_{d}⁺A^{d-} (1)

wherein (Z)_{d}⁺ is the cation component and A^{d-} is the anion component; where Z is (L-H) or a reducible Lewis Acid, L is an neutral Lewis base; H is hydrogen; (L-H)⁺ is a Bronsted acid; A^{d-} is a non-coordinating anion having the charge d−; and d is an integer from 1 to 3.

When Z is (L-H) such that the cation component is (L-H)_{d}⁺, the cation component may include Bronsted acids such as protonated Lewis bases capable of protonating a moiety, such as an alkyl or aryl, from the bulky ligand metallocene containing transition metal catalyst precursor, resulting in a cationic transition metal species. Preferably, the activating cation (L-H)_{d}⁺ is a Bronsted acid, capable of donating a proton to the transition metal catalytic precursor resulting in a transition metal cation, including ammoniums, oxoniums, phosphoniums, silyliums, and mixtures thereof, preferably ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, phosphoniums from triethylphosphine, triphenylphosphine, and diphenylphosphine, oxoniums from ethers, such as dimethyl ether diethyl ether, tetrahydrofuran, and dioxane, sulfoniums from thioethers, such as diethyl thioethers and tetrahydrothiophene, and mixtures thereof.

When Z is a reducible Lewis acid, (Z)_{d}⁺ is preferably represented by the formula: (Ar₃C)⁺, where Ar is aryl or aryl substituted with a heteroatom, a C₁ to C₄₀ hydrocarbyl, or a substituted C₁ to C₄₀ hydrocarbyl, preferably (Z)_{d}⁺ is represented by the formula: (Ph₃C)⁺, where Ph is phenyl or phenyl substituted with a heteroatom, a C₁ to C₄₀ hydrocarbyl, or a substituted C₁ to C₄₀ hydrocarbyl. In a preferred embodiment, the reducible Lewis acid is triphenyl carbenium.

The anion component A^{d-} includes those having the formula [M^{k+}Qₙ]^{d-} wherein k is 1, 2, or 3; n is 1, 2, 3, 4, 5, or 6, preferably 3, 4, 5 or 6; (n−k)=d; M is an element selected from group 13 of the Periodic Table of the Elements, preferably boron or aluminum; and each Q is, independently, a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than one occurrence is Q a halide, and two Q groups may form a ring structure. Preferably, each Q is a fluorinated hydrocarbyl group having 1 to 20 carbon atoms, more preferably each Q is a fluorinated aryl group, and most preferably each Q is a pentafluoryl aryl group. Examples of suitable A^{d-} components also include diboron compounds as disclosed in U.S. Pat. No. 5,447,895, which is fully incorporated herein by reference.

In other embodiments of this invention, the ionic stoichiometric activator may be an activator comprising expanded anions, represented by the formula:

(A*^{+a})_{b}(Z*J*ⱼ)^{-c}_{d};

wherein A* is a cation having charge +a; Z* is an anion group of from 1 to 50 atoms not counting hydrogen atoms, further containing two or more Lewis base sites; J* independently each occurrence is a Lewis acid coordinated to at least one Lewis base site of Z*, and optionally two or more such J* groups may be joined together in a moiety having multiple Lewis acid functionality; J is a number from 2 to 12; and a, b, c, and d are integers from 1 to 3, with the proviso that a×b is equal to c×d. Examples of such activators comprising expandable anions may be found in U.S. Pat. No. 6,395,671, which is fully incorporated herein by reference.

Illustrative examples of ionic stoichiometric activators useful in this invention include: triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, and triphenylcarbenium tetrakis(3,5-bis(trifluoromethyl)phenyl)borate.

### Metallocene Compounds

Metallocene compounds useful in embodiments of this invention may be represented by the formula:

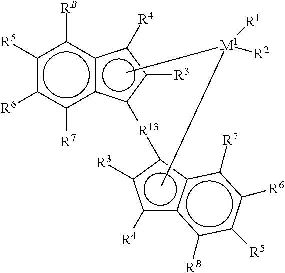

wherein:
M¹ is selected from titanium, zirconium, hafnium, vanadium, niobium, tantalum, chromium, molybdenum and tungsten (preferably M¹ is selected from zirconium, hafnium, or titanium, more preferably zirconium);
R¹ and R² are selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and substituted or unsubstituted C₇ to C₄₀ arylalkenyl groups; optionally R¹ and R² are joined together to form a C₄ to C₄₀ alkanediyl group or a conjugated C₄ to C₄₀ diene ligand which is coordinated to M¹ in a metallacyclopentene fashion; optionally, R¹ and R² represent a conjugated diene, optionally, substituted with one or more groups independently selected from hydrocarbyl, trihydrocarbylsilyl, and trihydrocarbylsilylhydrocarbyl groups, said diene having a total of up to 40 atoms not counting hydrogen and forming a π complex with M¹ (preferably R¹ and R² are independently selected from chlorine, substituted or unsubstituted C₁ to C₆ alkyl groups, substituted or unsubstituted C₆ to C₁₀ aryl groups, substituted or unsubstituted C₇ to C₁₂ arylalkyl groups and substituted or unsubstituted C₇ to C₁₂ alkylaryl groups, more preferably R¹ and R² are methyl groups);
each R³ and R^{B} is independently selected from hydrogen, halogen, substituted or unsubstituted C₁ to C₁₀ alkyl groups, substituted or unsubstituted C₆ to C₁₄ aryl groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups, substituted or unsubstituted C₈ to C₄₀ arylalkenyl groups, and —NR′₂, —SR′, —OR′, —SiR′₃, —OSiR′₃, and —PR′₂ radicals, wherein each R′ is independently selected from halogen, substituted or unsubstituted C₁ to C₁₀ alkyl groups and substituted or unsubstituted C₆ to C₁₄ aryl groups (preferably each R³ is selected from substituted or unsubstituted C₃ to C₆ alkyl groups and phenyl, more preferably at least one R³ is an isopropyl group);
R⁴, R⁵, R⁶, and R⁷ are each selected from the group consisting of hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and C₇ to C₄₀ substituted or unsubstituted arylalkenyl groups (preferably R⁴ is hydrogen or a C₁ to C₁₀ alkyl groups; preferably each of R⁵, R⁶, and R⁷ are substituted or unsubstituted C₁ to C₁₀ alkyl groups, preferably ethyl, isopropyl, alkoxy, amido, carbazoles or indoles); and
R¹³ is selected from:

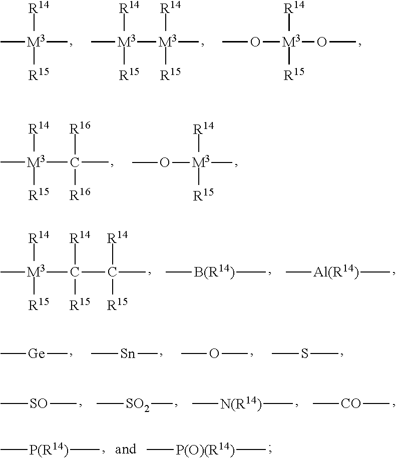

wherein:
R¹⁴, R¹⁵, and R¹⁶ are each independently selected from hydrogen, halogen, substituted or unsubstituted C₁ to C₂₀ alkyl groups, substituted or unsubstituted C₆ to C₃₀ aryl groups, substituted or unsubstituted C₁ to C₂₀ alkoxy groups, substituted or unsubstituted C₂ to C₂₀ alkenyl groups, substituted or unsubstituted C₇ to C₄₀ arylalkyl groups, substituted or unsubstituted C₈ to C₄₀ arylalkenyl groups and substituted or unsubstituted C₇ to C₄₀ alkylaryl groups, optionally R¹⁴ and R¹⁵, together with the atom(s) connecting them, form a ring; and
M³ is selected from carbon, silicon, germanium and tin; or
R¹³ is represented by the formula:

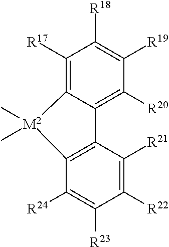

wherein:
R¹⁷, R¹⁸, R¹⁹, R²⁰, R²¹, R²², R²³, and R²⁴ are each independently selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ alkylaryl groups, substituted or unsubstituted C₇ to C₄₀ alkylaryl groups and substituted or unsubstituted C₈-C₄₀ arylalkenyl groups; optionally two or more adjacent radicals R¹⁷, R¹⁸, R¹⁹, R²⁰, R²¹, R²², R²³, and R²⁴, including R²⁰ and R²¹, together with the atoms connecting them, form one or more rings; and
M² represents one or more carbon atoms, or a silicon, germanium, or tin atom.

Preferably, each R^{B} is hydrogen, R¹³ is Si(CH₃)₂, and M¹ is zirconium. Preferably, each R³ is methyl, each R^{B} is hydrogen, R¹³ is Si(CH₃)₂, and M¹ is zirconium. Preferably, each R^{B} is phenyl, each R³ is methyl, R¹³ is Si(CH₃)₂, and M¹ is zirconium.

In preferred embodiments, the metallocene compound is represented by the formula:

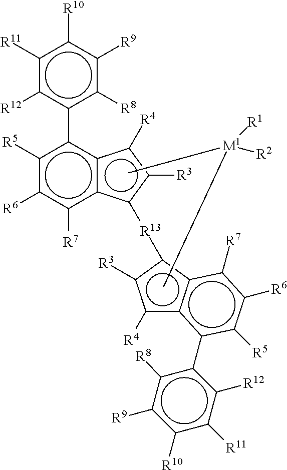

wherein:
M¹; R¹ and R²; R³; R⁴, R⁵, R⁶, R⁷, and R¹³ are as defined above (preferably each R³ is independently selected from isopropyl, isobutyl, sec-butyl, tert-butyl and phenyl groups, and each R¹² is independently selected from n-propyl, isopropyl, n-butyl, isobutyl, sec-butyl, tert-butyl, phenyl, tolyl, benzyl and naphthyl groups);
R⁸, R⁹, R¹⁰, and R¹¹ are each independently selected from hydrogen, halogen, substituted or unsubstituted C₁ to C₁₀ alkyl groups, substituted or unsubstituted C₆ to C₁₄ aryl groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups, substituted or unsubstituted C₈ to C₄₀ arylalkenyl groups, and —NR′₂, —SR′, —OR′, —SiR′₃, —OSiR′₃, and —PR′₂ radicals wherein each R′ is as defined above; and
R¹² is selected from halogen, substituted or unsubstituted C₂ to C₁₀ alkyl groups, substituted or unsubstituted C₆ to C₁₄ aryl groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups, substituted or unsubstituted C₈ to C₄₀ arylalkenyl groups, and —NR′₂, —SR′, —OR′, —SiR′₃, —OSiR′₃, and —PR′₂ radicals, wherein each R′ is as defined above (preferably each R¹² is independently selected from substituted or unsubstituted C₁ to C₆ alkyl groups and substituted or unsubstituted C₆ to C₁₀ aryl groups; more preferably, at least one R¹² is phenyl). Such metallocene compounds are further described in U.S. Pat. No. 7,122,498, which is fully incorporated herein.

Preferably, the metallocene compound is represented by one or more of the formulae:

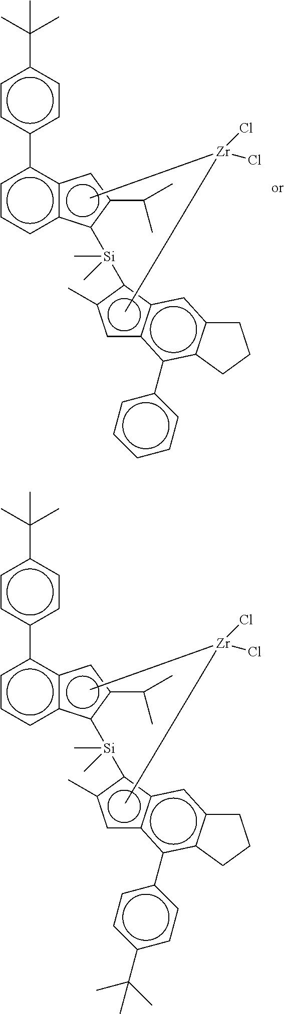

or the methyl analogs thereof.

Particularly useful metallocene compounds include:
dimethylsilanediylbis[2-t-butylmethyl-4-(1-naphthyl)-indenyl]zirconiumdichloride;
dimethylsilanediylbis[2-t-butylmethyl-4-(2-naphthyl)-indenyl]zirconiumdichloride;
dimethylsilanediylbis[2-t-butylmethyl-4-(4-methyl-phenyl)-indenyl]zirconiumdichloride;
dimethylsilanediylbis[2-t-butylmethyl-4-(4-biphenyl)-indenyl]zirconiumdichloride;
dimethylsilanediylbis[2-t-butylmethyl-4-(4-ethylphenyl)-indenyl]zirconiumdichloride;
dimethylsilanediylbis[2-t-butylmethyl-4-(4-n-propyl-phenyl)-indenyl]zirconiumdichloride;
dimethylsilanediylbis[2-t-butylmethyl-4-(4-i-propyl-phenyl)-indenyl]zirconiumdichloride;
dimethylsilanediylbis[2-t-butylmethyl-4-(4-t-butyl-phenyl)-indenyl]zirconiumdichloride;
dimethylsilanediylbis[2-t-butylmethyl-4-(4-sec-buty-1-phenyl)-indenyl]zirconiumdichloride;
dimethylsilanediylbis[2-t-butylmethyl-4-(4-cyclohexyl-phenyl)-indenyl]zirconiumdichloride;
dimethylsilanediylbis[2-t-butylmethyl-4-(4-trimethylsilylphenyl)indenyl]zirconiumdichloride;
dimethylsilanediylbis[2-t-butylmethyl-4-(4-adamantyl-phenyl)-indenyl]zirconiumdichloride;
dimethylsilanediylbis[2-t-butylmethyl-4-(3-biphenyl)-indenyl]zirconiumdichloride;
dimethylsilanediylbis[2-t-butylmethyl-4-(3,5-dimethyl-phenyl)-indenyl]zirconiumdichloride;
dimethylsilanediylbis[2-t-butylmethyl-4-(3,5-di(trifluoromethyl)phenyl)indenyl]zirconiumdichloride;
dimethylsilanediylbis[2-t-butylmethyl-4-(3,5-terphenyl)-indenyl]zirconiumdichloride;
dimethylsilanediylbis[2-cyclopentylmethyl-4-(1-naphthyl)-indenyl]zirconiumdichloride;
dimethylsilanediylbis[2-cyclopentylmethyl-4-(2-naphthyl)-indenyl]zirconiumdichloride;
dimethylsilanediylbis[2-cyclopentylmethyl-4-(4-methyl-phenyl)-indenyl]zirconiumdichloride;
dimethylsilanediylbis[2-cyclopentylmethyl-4-(4-biphenyl)-indenyl]zirconiumdichloride;
dimethylsilanediylbis[2-cyclopentylmethyl-4-(4-ethyl-phenyl)-indenyl]zirconiumdichloride;
dimethylsilanediylbis[2-cyclopentylmethyl-4-(4n-propyl-phenyl)indenyl]zirconiumdichloride;
dimethylsilanediylbis[2-cyclopentylmethyl-4-(4i-propyl-phenyl)indenyl]zirconiumdichloride;
dimethylsilanediylbis[2-cyclopentylmethyl-4-(4-t-butyl-phenyl)-indenyl]zirconiumdichloride;
dimethylsilanediylbis[2-cyclopentylmethyl-4-(4sec-butyl-phenyl)indenyl]zirconiumdichloride;
dimethylsilanediylbis[2-cyclopentylmethyl-4-(4cyclohexyl-phenyl)-indenyl]zirconiumdichloride;
dimethylsilanediylbis[2-cyclopentylmethyl-4-(4-trimethylsilyl-phenyl)-indenyl]zirconiumdichloride;
dimethylsilanediylbis[2-cyclopentylmethyl-4-(4 adamantyl-phenyl)-indenyl]zirconiumdichloride;
dimethylsilanediylbis[2-cyclopentylmethyl-4-(3-biphenyl)-indenyl]zirconiumdichloride;
dimethylsilanediylbis[2-cyclopentylmethyl-4-(3,5-dimethyl-phenyl)-indenyl]zirconiumdichloride;
dimethylsilanediylbis[2-cyclopentylmethyl-4-(3,5-di-(trifluoromethyl)-phenyl)-indenyl]zirconiumdichloride;
dimethylsilanediylbis[2-cyclopentylmethyl-4-(3,5-terphenyl)-indenyl]zirconiumdichloride;
dimethylsilanediylbis[2-cyclohexylmethyl-4-(1-naphthyl)-indenyl]zirconiumdichloride;
dimethylsilanediylbis[2-cyclohexylmethyl-4-(2naphthyl)-indenyl]zirconiumdichloride;
dimethylsilanediylbis[2-cyclohexylmethyl-4-(4-methyl-phenyl)-indenyl]zirconiumdichloride;
dimethylsilanediylbis[2-cyclohexylmethyl-4-(4-biphenyl)-indenyl]zirconiumdichloride;
dimethylsilanediylbis[2-cyclohexylmethyl-4-(4-ethyl-phenyl)-indenyl]zirconiumdichloride;
dimethylsilanediylbis[2-cyclohexylmethyl-4-(4-n-propylphenyl)-indenyl]zirconiumdichloride;
dimethylsilanediylbis[2-cyclohexylmethyl-4-(4-i-propylphenyl)-indenyl]zirconiumdichloride;
dimethylsilanediylbis[2-cyclohexylmethyl-4-(4-t-butyl-phenyl)-indenyl]zirconiumdichloride;
dimethylsilanediylbis[2-cyclohexylmethyl-4-(4sec-butyl-phenyl)indenyl]zirconiumdichloride;
dimethylsilanediylbis[2-cyclohexylmethyl-4-(4-cyclohexyl-phenyl)-indenyl]zirconiumdichloride;
dimethylsilanediylbis[2-cyclohexylmethyl-4-(4-trimethylsilyl-phenyl)-indenyl]zirconiumdichloride; and
dimethylsilanediylbis[2-cyclohexylmethyl-4-(4-adamantyl-phenyl)-indenyl]zirconiumdichloride; as well as the analogous zirconiumdimethyl and zirconium biphenolate and zirconium bisphenolate compounds. Other metallocene compounds described in U.S. Patent Pre-Grant Publication No. 2010/0267907, incorporated by reference herein, are also useful herein.

Other useful metallocene compounds include:
dimethylsilanediylbis{1-[2-n-propyl,4-(2-methylphenyl)indenyl]}zirconiumdichloride;
dimethylsilanediylbis{1-[2-isopropyl,4-(2-methylphenyl)indenyl]}zirconiumdichloride;
dimethylsilanediylbis{1-[2-n-butyl,4-(2-methylphenyl)indenyl]}zirconiumdichloride;
dimethylsilanediylbis{1-[2-isobutyl,4-(2-methylphenyl)indenyl]}zirconiumdichloride;
dimethylsilanediylbis{1-[2-sec-butyl,4-(2-methylphenyl)indenyl]}zirconiumdichloride;
dimethylsilanediylbis{1-[2-tert-butyl,4-(2-methylphenyl)indenyl]}zirconiumdichloride;
dimethylsilanediylbis{1-[2-phenyl,4-(2-methylphenyl)indenyl]}zirconiumdichloride;
dimethylsilanediylbis{1-[2-n-propyl,4-(2-ethylphenyl)indenyl]}zirconiumdichloride;
dimethylsilanediylbis{1-[2-isopropyl,4-(2-ethylphenyl)indenyl]}zirconiumdichloride;
dimethylsilanediylbis{1-[2-n-butyl,4-(2-ethylphenyl)indenyl]}zirconiumdichloride;
dimethylsilanediylbis{1-[2-isobutyl,4-(2-ethylphenyl)indenyl]}zirconiumdichloride;
dimethylsilanediylbis{1-[2-sec-butyl,4-(2-ethylphenyl)indenyl]}zirconiumdichloride;
dimethylsilanediylbis{1-[2-tert-butyl,4-(2-ethylphenyl)indenyl]}zirconiumdichloride;
dimethylsilanediylbis{1-[2-phenyl,4-(2-ethylphenyl)indenyl]}zirconiumdichloride;
dimethylsilanediylbis{1-[2-n-propyl,4-(2-n-propylphenyl)indenyl]}zirconiumdichloride;
dimethylsilanediylbis{1-[2-isopropyl,4-(2-n-propylphenyl)indenyl])}zirconiumdichloride;
dimethylsilanediylbis{1-[2-n-butyl,4-(2-n-propylphenyl)indenyl]}zirconiumdichloride;
dimethylsilanediylbis{1-[2-isobutyl,4-(2-n-propylphenyl)indenyl]}zirconiumdichloride;
dimethylsilanediylbis{1-[2-sec-butyl,4-(2-n-propylphenyl)indenyl]}zirconiumdichloride;
dimethylsilanediylbis{1-[2-tert-butyl,4-(2-n-propylphenyl)indenyl]}zirconiumdichloride;
dimethylsilanediylbis{1-[2-phenyl,4-(2-n-propylphenyl)indenyl]}zirconiumdichloride;
dimethylsilanediylbis{1-[2-n-propyl,4-(2-isopropylphenyl)indenyl]}zirconiumdichloride;
dimethylsilanediylbis{1-[2-isopropyl,4-(2-isopropylphenyl)indenyl]}zirconiumdichloride;
dimethylsilanediylbis{1-[2-n-butyl,4-(2-isopropylphenyl)indenyl]}zirconiumdichloride;
dimethylsilanediylbis{1-[2-isobutyl,4-(2-isopropylphenyl)indenyl]}zirconium dichloride;
dimethylsilanediylbis{1-[2-sec-butyl,4-(2-isopropylphenyl)indenyl]}zirconiumdichloride;
dimethylsilanediylbis{1-[2-tert-butyl,4-(2-isopropylphenyl)indenyl]}zirconiumdichloride;
and dimethylsilanediylbis{1-[2-phenyl,4-(2-isopropylphenyl)indenyl]}zirconiumdichloride; as well as the analogous zirconiumdimethyl compounds. Other metallocene compounds described in U.S. Pat. No. 7,122,498, incorporated fully by reference herein, are useful herein.

Yet other useful metallocene compounds include:
dimethylsilanediylbis(2-methylbenzindenyl)zirconiumdichloride;
dimethylsilanediylbis(2-methylindenyl)zirconiumdichloride;
dimethylsilanediylbis(2-methyl-4-(1-naphthyl)indenyl)zirconiumdichloride;
dimethylsilanediylbis(2-methyl-4-(2-naphthyl)indenyl)zirconiumdichloride;
dimethylsilanediylbis(2-methyl-4-phenylindenyl)zirconiumdichloride;
dimethylsilanediylbis(2-methyl-4-t-butylindenyl)zirconiumdichloride;
dimethylsilanediylbis(2-methyl-4-isopropylindenyl)zirconiumdichloride;
dimethylsilanediylbis(2-methyl-4-ethylindenyl)zirconiumdichloride;
dimethylsilanediylbis(2-methyl-4-acenaphthindenyl)zirconiumdichloride;
dimethylsilanediylbis(2,4-dimethylindenyl)zirconiumdichloride;
dimethylsilanediylbis(2-ethylindenyl)zirconiumdichloride;
dimethylsilanediylbis(2-ethyl-4-ethylindenyl)zirconiumdichloride;
dimethylsilanediylbis(2-ethyl-4-phenylindenyl)zirconiumdichloride;
dimethylsilanediylbis(2-methyl-4,5-benzindenyl)zirconiumdichloride;
dimethylsilanediylbis(2-methyl-4,6-diisopropylindenyl)zirconiumdichloride;
dimethylsilanediylbis(2-methyl-4,5-diisopropylindenyl)zirconiumdichloride;
dimethylsilanediylbis(2,4,6-trimethylindenyl)zirconiumdichloride;
dimethylsilanediylbis(2,5,6-trimethylindenyl)zirconiumdichloride;
dimethylsilanediylbis(2,4,7-trimethylindenyl)zirconiumdichloride;
dimethylsilanediylbis(2-methyl-5-isobutylindenyl)zirconiumdichloride;
dimethylsilanediylbis(2-methyl-5-t-butylindenyl)zirconiumdichloride;
methyl(phenyl)silanediylbis(2-methyl-4-phenylindenyl)zirconiumdichloride;
methyl(phenyl)silanediylbis(2-methyl-4,6-diisopropylindenyl)zirconiumdichloride;
methyl(phenyl)silanediylbis(2-methyl-4-isopropylindenyl)zirconiumdichloride;
methyl(phenyl)silanediylbis(2-methyl-4,5-benzindenyl)zirconiumdichloride;
methyl(phenyl)silanediylbis(2-methyl-4,5-(methylbenzindenyl)zirconiumdichloride; and
methyl(phenyl)silanediylbis(2-methyl-4,5(tetramethylbenzindenyl)zirconiumdichloride; as well as the analogous zirconiumdimethyl compounds. Other metallocene compounds described in U.S. Pat. No. 6,482,902, incorporated fully by reference herein, are also useful herein.

### Supported Metallocene Catalyst System

In some embodiments of this invention, this invention relates to a supported metallocene catalyst system produced by the process described above, the catalyst system comprising: (i) a metallocene compound comprising a group 4, 5, or 6 metal; (ii) an ionic stoichiometric activator represented by the formula: (Z)_{d}⁺A^{d-}, wherein (Z)_{d}⁺ is a cation, where Z is a reducible Lewis Acid, and A^{d-} is a non-coordinating anion having the charge d−, and d is 1, 2, or 3; and (iii) an alkyl aluminum treated support material, wherein the alkyl aluminum compound is represented by the formulae: R₃Al, wherein each R group is, independently, a substituted or unsubstituted C₁ to C₁₂ alkyl group, Cl or F with the proviso that at least one R group is a C₁ to C₁₂ alkyl group; wherein the supported metallocene catalyst system has a catalyst productivity of greater than 50 g polymer/g(cat)/hour.

More particularly, this invention also relates to a supported metallocene catalyst system comprising: (i) an aluminum alkyl treated support material; wherein the aluminum alkyl treated support material is the reaction product of a support material and an alkyl aluminum; wherein the support material is selected from the group consisting of SiO₂, Al₂O₃, or SiO₂/Al₂O₃; and wherein the alkyl aluminum is represented by the formula: R₃Al; wherein each R group is, independently, a substituted or unsubstituted C₁ to C₁₂ alkyl group, Cl or F with the proviso that at least one R group is a C₁ to C₁₂ alkyl group; (ii) an ionic stoichiometric activator, wherein the ionic stoichiometric activator is represented by the formula: (Z)_{d}⁺A^{d-}, wherein (Z)_{d}⁺ is a cation, where Z is a reducible Lewis Acid; and A^{d-} is a non-coordinating anion having the charge d−, and d is 1, 2, or 3; and (iii) a metallocene compound represented by the formula:

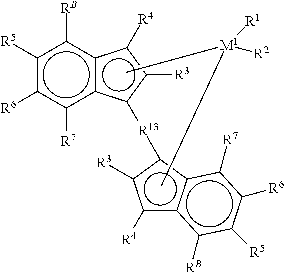

wherein:
M¹ is selected from titanium, zirconium, hafnium, vanadium, niobium, tantalum, chromium, molybdenum and tungsten; R¹ and R² are selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and substituted or unsubstituted C₇ to C₄₀ arylalkenyl groups; optionally R¹ and R² are joined together to form a C₄ to C₄₀ alkanediyl group or a conjugated C₄ to C₄₀ diene ligand which is coordinated to M¹ in a metallacyclopentene fashion; optionally R¹ and R² represent a conjugated diene, optionally substituted with one or more groups independently selected from hydrocarbyl, trihydrocarbylsilyl and trihydrocarbylsilylhydrocarbyl groups, said diene having a total of up to 40 atoms not counting hydrogen and forming a π complex with M¹; each R³ and R^{B} is independently selected from hydrogen, halogen, substituted or unsubstituted C₁ to C₁₀ alkyl groups, substituted or unsubstituted C₆ to C₁₄ aryl groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups, substituted or unsubstituted C₈ to C₄₀ arylalkenyl groups, and —NR′₂, —SR′, —OR′, —SiR′₃, —OSiR′₃, and —PR′₂ radicals wherein each R′ is independently selected from halogen, substituted or unsubstituted C₁ to C₁₀ alkyl groups and substituted or unsubstituted C₆ to C₁₄ aryl groups; R⁴, R⁵, R⁶, and R⁷ are each selected from the group consisting of hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and C₇ to C₄₀ substituted or unsubstituted arylalkenyl groups; and R¹³ is selected from:

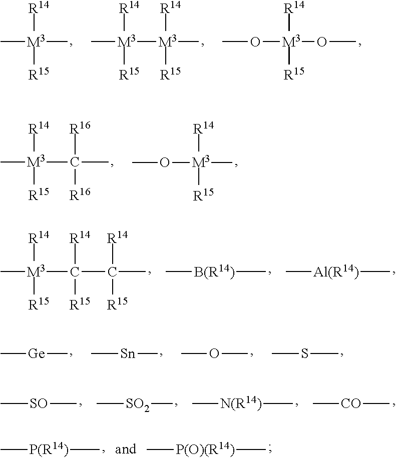

wherein: R¹⁴, R¹⁵, and R¹⁶ are each independently selected from hydrogen, halogen, C₁ to C₂₀ alkyl groups, C₆ to C₃₀ aryl groups, C₁ to C₂₀ alkoxy groups, C₂ to C₂₀ alkenyl groups, C₇ to C₄₀ arylalkyl groups, C₈ to C₄₀ arylalkenyl groups and C₇ to C₄₀ alkylaryl groups, optionally, R¹⁴ and R¹⁵, together with the atom(s) connecting them, form a ring; and M³ is selected from carbon, silicon, germanium, and tin; or R¹³ is represented by the formula:

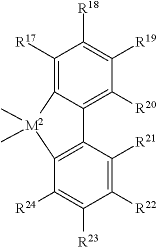

wherein: R¹⁷, R¹⁸, R¹⁹, R²⁰, R²¹, R²², R²³, and R²⁴ are each independently selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ alkylaryl groups, substituted or unsubstituted C₇ to C₄₀ alkylaryl groups and substituted or unsubstituted C₈ to C₄₀ arylalkenyl groups; optionally, two or more adjacent radicals R¹⁷, R¹⁸, R¹⁹, R²⁰, R²¹, R²², R²³, and R²⁴, including R²⁰ and R²¹, together with the atoms connecting them, form one or more rings; and M² represents one or more carbon atoms, or a silicon, germanium or tin atom.

In preferred embodiments of this invention, the supported metallocene catalyst system comprises from about 0.05 wt % to about 2.0 wt % group 4, 5, or 6 metal, based on the total weight of the catalyst system. In preferred embodiments of this invention, the supported metallocene catalyst system comprises about from about 0.02 to about 0.08 mmol of aluminum per gram of supported metallocene catalyst system (preferably, the supported metallocene catalyst system comprises from about 0.04 mmol to about 0.08 mmol of aluminum per gram of supported metallocene catalyst system).

### Polymerization Processes

This invention also relates to polymerization processes comprising: (i) contacting a support material with an alkyl aluminum compound to provide an aluminum alkyl treated support material, wherein the alkyl aluminum compound is represented by the formula: R₃Al; wherein each R group is, independently, a substituted or unsubstituted C₁ to C₁₂ alkyl group, Cl or F, with the proviso that at least one R group is a C₁ to C₁₂ alkyl group; (ii) contacting a metallocene compound comprising a group 4, 5, or 6 metal with the alkyl aluminum treated support material of step (i); (iii) contacting an ionic stoichiometric activator with the aluminum alkyl treated support material of step (i), wherein the ionic stoichiometric activator is represented by the formula: (Z)_{d}⁺A^{d-}, wherein (Z)_{d}⁺ is a cation, where Z is a reducible Lewis Acid, A^{d-} is a non-coordinating anion having the charge d−, and d is 1, 2, or 3; (iv) obtaining a supported metallocene catalyst system; (v) contacting one or more C₂ to C₄₀ olefin monomers with the supported metallocene catalyst system under polymerization conditions; and (vi) obtaining an olefin polymer.

The metallocene catalyst systems described herein are useful in the polymerization of all types of olefins. This includes polymerization processes which produce homopolymers, copolymers, terpolymers, and the like, as well as block copolymers and impact copolymers.

Monomers useful herein include substituted or unsubstituted C₂ to C₄₀ olefins, preferably C₂ to C₂₀ olefins, preferably C₂ to C₁₂ olefins, preferably ethylene, propylene, butene, pentene, hexene, heptene, octene, nonene, decene, undecene, dodecene and isomers thereof, preferably alpha olefins. In a preferred embodiment of the invention, the monomer comprises propylene and optional comonomers comprising one or more ethylene or C₄ to C₄₀ olefins, preferably C₄ to C₂₀ olefins, or preferably C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups. In another preferred embodiment, the monomer comprises ethylene and optional comonomers comprising one or more C₃ to C₄₀ olefins, preferably C₄ to C₂₀ olefins, or preferably C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and/or one or more functional groups.

Examples of C₂ to C₄₀ olefin monomers and optional comonomers include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, preferably hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, preferably norbornene, norbornadiene, and dicyclopentadiene. Preferably, the polymerization or copolymerization is carried out using olefins such as ethylene, propylene, 1-butene, 1-hexene, 4-methyl-1-pentene, and 1-octene, vinylcyclohexane, norbornene and norbornadiene. In particular, propylene and ethylene are polymerized.

In some embodiments, where butene is the comonomer, the butene source may be a mixed butene stream comprising various isomers of butene. The 1-butene monomers are expected to be preferentially consumed by the polymerization process. Use of such mixed butene streams will provide an economic benefit, as these mixed streams are often waste streams from refining processes, for example, C₄ raffinate streams, and can therefore be substantially less expensive than pure 1-butene.

Polymerization processes of this invention can be carried out in any manner known in the art, in solution, in suspension or in the gas phase, continuously or batchwise, or any combination thereof, in one or more steps. Homogeneous polymerization processes, slurry, and gas phase processes are preferred. (A homogeneous polymerization process is defined to be a process where at least 90 wt % of the product is soluble in the reaction media.) A bulk homogeneous process is particularly preferred. (A bulk process is defined to be a process where monomer concentration in all feeds to the reactor is 70 volume % or more.) Alternately, no solvent or diluent is present or added in the reaction medium, (except for the small amounts used as the carrier for the catalyst system or other additives, or amounts typically found with the monomer; e.g., propane in propylene). In another embodiment, the process is a slurry process. As used herein the term “slurry polymerization process” means a polymerization process where a supported catalyst is employed and monomers are polymerized on the supported catalyst particles and at least 95 wt % of polymer products derived from the supported catalyst are in granular form as solid particles (not dissolved in the diluent).

If the polymerization is carried out as a suspension or solution polymerization, an inert solvent may be used, for example, the polymerization may be carried out in suitable diluents/solvents. Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In a preferred embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, preferably aromatics are present in the solvent at less than 1 wt %, preferably less than 0.5 wt %, preferably less than 0 wt %, based upon the weight of the solvents. It is also possible to use mineral spirit or a hydrogenated diesel oil fraction as a solvent. Toluene may also be used. The polymerization is preferably carried out in the liquid monomer(s). If inert solvents are used, the monomer(s) is (are) metered in gas or liquid form.

In a preferred embodiment, the feed concentration of the monomers and comonomers for the polymerization is 60 vol % solvent or less, preferably 40 vol % or less, or preferably 20 vol % or less, based on the total volume of the feedstream. Preferably, the polymerization is run in a bulk process.

Preferred polymerizations can be run at any temperature and/or pressure suitable to obtain the desired polymers. Typical temperatures and/or pressures include a temperature greater than 30° C., preferably greater than 50° C., preferably greater than 65° C., alternately less than 200° C., preferably less than 150° C., most preferably less than 140° C., and at a pressure in the range of from about 0.35 MPa to about 10 MPa, preferably from about 0.45 MPa to about 6 MPa, or preferably from about 0.5 MPa to about 4 MPa.

In a typical polymerization, the run time of the reaction is up to 300 minutes, preferably in the range of from about 5 to 250 minutes, or preferably from about 10 to 120 minutes.

If necessary, hydrogen is added as a molecular-weight regulator and/or in order to increase the activity. The overall pressure in the polymerization system usually is at least about 0.5 bar, preferably at least about 2 bar, most preferred at least about 5 bar. Pressures higher than about 100 bar, e.g., higher than about 80 bar and, in particular, higher than about 64 bar, are usually not preferred. In some embodiments, hydrogen is present in the polymerization reactor at a partial pressure of from 0.001 to 100 psig (0.007 to 690 kPa), preferably from 0.001 to 50 psig (0.007 to 345 kPa), preferably from 0.01 to 25 psig (0.07 to 172 kPa), more preferably 0.1 to 10 psig (0.7 to 70 kPa).

In an alternate embodiment, the productivity of the catalyst is at least 50 gpolymer/g (cat)/hour, preferably 500 or more gpolymer/g (cat)/hour, preferably 5000 or more gpolymer/g (cat)/hour, preferably 50,000 or more gpolymer/g (cat)/hour.

In an alternate embodiment, the conversion of olefin monomer is at least 10%, based upon polymer yield and the weight of the monomer entering the reaction zone, preferably 20% or more, preferably 30% or more, preferably 50% or more, preferably 80% or more. A “reaction zone”, also referred to as a “polymerization zone”, is a vessel where polymerization takes place, for example, a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In preferred embodiments, the polymerization occurs in one, two, three, four, or more reaction zones.

In a preferred embodiment, little or no alumoxane is used in the process to produce the polymers. Preferably, alumoxane is present at zero mol %, alternately the alumoxane is present at a molar ratio of aluminum to transition metal less than 500:1, preferably less than 300:1, preferably less than 100:1, preferably less than 1:1.

In a preferred embodiment, the polymerization: 1) is conducted at a temperature greater than 30° C. (preferably greater than 50° C., preferably greater than 65° C., alternately less than 200° C., preferably less than 150° C., most preferred less than 140° C.); 2) is conducted at in the range of from about 0.35 MPa to about 10 MPa (preferably from about 0.45 MPa to about 6 MPa, or preferably from about 0.5 MPa to about 4 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; preferably, where aromatics are preferably present in the solvent at less than 1 wt %, preferably less than 0.5 wt %, preferably at 0 wt % based upon the weight of the solvents); 4) wherein the catalyst system used in the polymerization comprises less than 0.5 mol %, preferably 0 mol % alumoxane, alternately, the alumoxane is present at a molar ratio of aluminum to transition metal less than 500:1, preferably less than 300:1, preferably less than 100:1, preferably less than 1:1; 5) the polymerization preferably occurs in one, two, three, four, or more reaction zones; 6) the productivity of the catalyst system is at least 50 gpolymer/g (cat)/hour (preferably 500 or more gpolymer/g (cat)/hour, preferably 5000 or more gpolymer/g (cat)/hour, preferably 50,000 or more gpolymer/g (cat)/hour); and 7) optionally, hydrogen is present in the polymerization reactor at a partial pressure of from 0.001 to 100 psig (0.007 to 690 kPa) (preferably from 0.001 to 50 psig (0.007 to 345 kPa), preferably from 0.01 to 25 psig (0.07 to 172 kPa), more preferably 0.1 to 10 psig (0.7 to 70 kPa)).

In a preferred embodiment, the catalyst system used in the polymerization comprises no more than one catalyst compound.

Other additives may also be used in the polymerization, as desired, such as one or more scavengers, promoters, modifiers, chain transfer agents (such as diethyl zinc), reducing agents, oxidizing agents, hydrogen, aluminum alkyls, or silanes.

In preferred embodiments of this invention, the polymerization process comprises contacting the supported metallocene catalyst system with propylene monomer to make polypropylene in a first stage.

In preferred embodiments of this invention, the polymerization process further comprises contacting the polypropylene with the same or different supported metallocene catalyst system in the presence of ethylene to produce an impact copolymer in a second stage. In another preferred embodiment of this invention, the polymerization process further comprises contacting the polypropylene with the same or different supported metallocene catalyst system in the presence of ethylene and one or more C₄ to C₄₀ olefin monomers to produce an impact copolymer in a second stage.

### Polyolefin Products

This invention also relates to polyolefins produced using the supported metallocene catalyst systems of this invention, particularly propylene and ethylene homopolymers and copolymers.

In a preferred embodiment, the process described herein produces propylene homopolymers or propylene copolymers, such as propylene-ethylene and/or propylene-α-olefin (preferably C₂, and/or C₄ to C₂₀) copolymers (such as propylene-hexene copolymers, propylene-octene copolymers, or propylene-ethylene-hexene terpolymers) having a Mw/Mn of greater than 1 to 40 (preferably greater than 1 to 5). Preferably, copolymers of propylene have from 0 wt % to 25 wt % (alternately from 0.5 wt % to 20 wt %, alternately from 1 wt % to 15 wt %, preferably from 3 wt % to 10 wt %, preferably less than 1 wt %, preferably 0 wt %) of one or more of C₂ or C₄ to C₄₀ olefin comonomer (preferably ethylene or C₄ to C₂₀ or C₄ to C₁₂ alpha olefin comonomer, preferably ethylene, butene, hexene, octene, decene, dodecene, preferably ethylene, butene, hexene, or octene).

In another preferred embodiment, the process described herein produces ethylene homopolymers or copolymers, such as ethylene-propylene and/or ethylene-α-olefin (preferably C₃ and/or C₄ to C₂₀) copolymers (such as ethylene-hexene copolymers, ethylene-octene copolymers, or ethylene-propylene-hexene terpolymers) having a Mw/Mn of greater than 1 to 40 (preferably greater than 1 to 5). Preferably, copolymers of ethylene have from 0 wt % to 25 wt % (alternately from 0.5 wt % to 20 wt %, alternately from 1 wt % to 15 wt %, preferably from 3 wt % to 10 wt %, preferably less than 1 wt %, preferably O wt %) of one or more of C₃ to C₄₀ olefin comonomer (preferably propylene or C₃ to C₂₀ or C₄ to C₁₂ alpha olefin comonomer, preferably propylene, butene, hexene, octene, decene, dodecene, preferably ethylene, butene, hexene, and octene).

In another preferred embodiment, the process described herein produces propylene homopolymers or copolymers described above in a first stage or first reaction zone, and ethylene homopolymers or copolymers described above in a second stage or second reaction zone.

In particularly preferred embodiments, the propylene polyolefins produced herein have exceptionally high molecular weight and melting point, even when used in processes under commercially relevant conditions of temperature, pressure, and catalyst productivity.

Typically, the polymers produced herein have an Mw of 5,000 to 1,000,000 g/mol (preferably 25,000 to 750,000 g/mol, preferably 50,000 to 500,000 g/mol) and/or an Mw/Mn of greater than 1 to 40 (alternately 1.2 to 20, alternately 1.3 to 10, alternately 1.4 to 5, alternately 1.5 to 4, alternately 1.5 to 3). Unless otherwise indicated Mw, Mn, and MWD are determined by GPC as described in US 2006/0173123 pp. 24-25, paragraphs [0334] to [0341].

In a preferred embodiment, the polymer produced herein has a unimodal or multimodal molecular weight distribution as determined by Gel Permeation Chromatography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versus).

Preferred melting points of propylene polymers produced herein, preferably comprising at least about 99% by weight, preferably at least about 99.3% by weight, preferably at least 99.5% by weight, preferably 100% by weight of units derived from propylene (the remainder being preferably derived from one or more compounds selected from ethylene and C₄ to C₄₀ alpha olefin monomers, most preferred ethylene) are 153° C. or greater, preferably 155° C. or greater, preferably 157° C. or greater, preferably 160° C. or greater, and preferably 162° C. or greater; alternately 180° C. or less, alternately 175° C. or less, alternately 170° C. or less, alternately 165° C. or less (these melting points being second melt, determined by DSC according to the procedure described in the Examples below).

In preferred embodiments, the polyolefins produced herein (preferably ethylene or propylene polymers) have one or more of the following properties: (i) 0 wt % to 25 wt % (alternately from 0.5 wt % to 20 wt %, alternately from 1 wt % to 15 wt %, preferably from 3 wt % to 10 wt %, preferably less than 1 wt %, preferably O wt %) of one or more of C₂ to C₄₀ olefin comonomer (preferably propylene and/or ethylene and optionally C₄ to C₂₀ or C₄ to C₁₂ alpha olefin termonomer (preferably 1-butene, 1-hexene, 1-octene, 1-decene, and/or 1-dodecene; more preferably 1-butene, 1-hexene, and/or 1-octene)); (ii) an Mw of 5,000 to 1,000,000 g/mol (preferably 25,000 to 750,000 g/mol, preferably 50,000 to 500,000 g/mol); (iii) an Mw/Mn of greater than 1 to 40 (alternately 1.2 to 20, alternately 1.3 to 10, alternately 1.4 to 5, alternately 1.5 to 4, alternately 1.5 to 3); and (iv) a melting point of 153° C. or greater (preferably 155° C. or greater, preferably 157° C. or greater, preferably 160° C. or greater, and preferably 162° C. or greater; alternately 180° C. or less, alternately 175° C. or less, alternately 170° C. or less, alternately 165° C. or less).

### Uses of Polyolefins

Polyolefins prepared using the processes described herein find uses in all applications including fibers, injection molded parts, films, pipes, and wire and cable applications. Examples include carpet fibers and primary and secondary carpet backing; slit tape applications such as tarpaulins, erosion abatement screens, sand bags, fertilizer and feed bags, swimming pool covers, intermediate bulk container (IBC) bags; non-woven applications for spun-bonded, melt blown and thermobonded fibers; carded web applications such as disposable diaper liners, feminine hygiene products, tarpaulins and tent fabrics, and hospital garments; apparel applications such as socks, T-shirts, undergarments, bicycle shorts, sweat bands, football undershirts, hiking socks, and other outdoor sporting apparel; cordage applications such as mooring and towing lines and rope; netting applications such as safety fences and geogrids for soil stabilization; injection molded applications such as appliance parts in automatic dishwashers and clothes washers, hand tools, and kitchen appliances; consumer product applications such as outdoor furniture, luggage, infant car seats, ice coolers, yard equipment; medical applications such as disposable syringes and other hospital and laboratory devices; rigid packaging made by injection molding, blow molding, or thermoforming such as margarine tubs, yogurt containers and closures, commercial bottles, and ready-to-eat food containers; transportation applications such as automotive interior trim, instrument panels, bumper fascia, grills and external trim parts, battery cases; film applications such as snack packages and other food packaging and film labels, packing tapes and pressure sensitive labels; wire and cable applications such as wire insulation.

The polyolefins described herein may be used by themselves or blended with one or more additional polymers. In another embodiment, the polyolefin (preferably propylene or ethylene homopolymer or copolymer) produced herein is combined with one or more additional polymers prior to being formed into a film, molded part, or other article. Useful additional polymers include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE (low density polyethylene), LLDPE (linear low density polyethylene), HDPE (high density polyethylene), ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM (ethylene-propylene-diene monomer rubber), block copolymer, styrenic block copolymers, polyamides, polycarbonates, PET (polyethylene terephthalate) resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In a preferred embodiment, the polyolefin (preferably propylene or ethylene homopolymer or copolymer) is present in the above blends, at from 10 wt % to 99 wt %, based upon the weight of the polymers in the blend, preferably 20 wt % to 95 wt %, even more preferably at least 30 wt % to 90 wt %, even more preferably at least 40 wt % to 90 wt %, even more preferably at least 50 wt % to 90 wt %, even more preferably at least 60 wt % to 90 wt %, even more preferably at least 70 wt % to 90 wt %.

The blends described above may be produced by mixing the polyolefins of the invention with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

The blends may be formed using conventional equipment and methods, such as by dry blending the individual components and subsequently melt mixing in a mixer, or by mixing the components together directly in a mixer, such as, for example, a BANBURY™ mixer, a HAAKE™ mixer, a BRABENDER™ internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc; and the like.

### Films

In particular embodiments, the polyolefins produced herein, or blends thereof, may be used in film applications, for example, mono- or multi-layer blown, extruded, and/or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble processes and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically, the films are oriented in the Machine Direction (MD) at a ratio of up to 15, preferably between 5 and 7, and in the Transverse Direction (TD) at a ratio of up to 15, preferably 7 to 9. However, in another embodiment the film is oriented to the same extent in both the MD and TD directions.

The films may vary in thickness depending on the intended application; however, films of a thickness from 1 to 50 μm are usually suitable. Films intended for packaging are usually from 10 to 50 μm thick. The thickness of the sealing layer is typically 0.2 to 50 μm. There may be a sealing layer on both the inner and outer surfaces of the film or the sealing layer may be present on only the inner or the outer surface.

In another embodiment, one or more layers may be modified by corona treatment, electron beam irradiation, gamma irradiation, flame treatment, or microwave. In a preferred embodiment, one or both of the surface layers is modified by corona treatment.

### Molded Products

The polyolefins or blends thereof described herein may also be used to prepare molded products in any molding process, including but not limited to, injection molding, gas-assisted injection molding, extrusion blow molding, injection blow molding, injection stretch blow molding, compression molding, rotational molding, foam molding, thermoforming, sheet extrusion, and profile extrusion. The molding processes are well known to those of ordinary skill in the art.

Further, the polyolefins (preferably polypropylene) or blends thereof may be shaped into desirable end use articles by any suitable means known in the art. Thermoforming, vacuum forming, blow molding, rotational molding, slush molding, transfer molding, wet lay-up or contact molding, cast molding, cold forming matched-die molding, injection molding, spray techniques, profile co-extrusion, or combinations thereof are typically used methods.

Thermoforming is a process of forming at least one pliable plastic sheet into a desired shape. Typically, an extrudate film of the composition of this invention (and any other layers or materials) is placed on a shuttle rack to hold it during heating. The shuttle rack indexes into the oven which pre-heats the film before forming Once the film is heated, the shuttle rack indexes back to the forming tool. The film is then vacuumed onto the forming tool to hold it in place and the forming tool is closed. The tool stays closed to cool the film and the tool is then opened. The shaped laminate is then removed from the tool. The thermoforming is accomplished by vacuum, positive air pressure, plug-assisted vacuum forming, or combinations and variations of these, once the sheet of material reaches thermoforming temperatures, typically of from 140° C. to 185° C. or higher. A pre-stretched bubble step is used, especially on large parts, to improve material distribution.

Blow molding is another suitable forming means for use with the compositions of this invention, which includes injection blow molding, multi-layer blow molding, extrusion blow molding, and stretch blow molding, and is especially suitable for substantially closed or hollow objects, such as, for example, gas tanks and other fluid containers. Blow molding is described in more detail in, for example, CONCISE ENCYCLOPEDIA OF POLYMER SCIENCE AND ENGINEERING 90-92 (Jacqueline I. Kroschwitz, ed., John Wiley & Sons 1990).

Likewise, molded articles may be fabricated by injecting molten polymer into a mold that shapes and solidifies the molten polymer into desirable geometry and thickness of molded articles. Sheets may be made either by extruding a substantially flat profile from a die, onto a chill roll, or alternatively by calendaring. Sheets are generally considered to have a thickness of from 10 mils to 100 mils (254 μm to 2540 μm), although any given sheet may be substantially thicker.

### Non-Wovens and Fibers

The polyolefins (preferably polypropylene) or blends thereof described above may also be used to prepare nonwoven fabrics and fibers of this invention in any nonwoven fabric and fiber making process, including but not limited to, melt blowing, spunbonding, film aperturing, and staple fiber carding. A continuous filament process may also be used. Preferably, a spunbonding process is used. The spunbonding process is well known in the art. Generally, it involves the extrusion of fibers through a spinneret. These fibers are then drawn using high velocity air and laid on an endless belt. A calender roll is generally then used to heat the web and bond the fibers to one another although other techniques may be used such as sonic bonding and adhesive bonding.

In another embodiment, the invention relates to:

1. A process to produce a supported metallocene catalyst system, the process comprising:
(i) contacting a support material with an alkyl aluminum compound to provide an alkyl aluminum treated support material (preferably the support material is SiO₂, Al₂O₃, or SiO₂/Al₂O₃);
wherein the alkyl aluminum compound is represented by the formula:

R₃Al;

wherein each R group is, independently, a substituted or unsubstituted C₁ to C₁₂ alkyl group, Cl or F with the proviso that at least one R group is a C₁ to C₁₂ alkyl group (preferably the alkyl aluminum compound is one or more of trimethyl aluminum, triethyl aluminum, tri-n-octyl aluminum, tri-isobutyl aluminum, tri-n-hexyl aluminum, and dimethyl aluminum fluoride);
(ii) contacting the alkyl aluminum treated support material with an ionic stoichiometric activator,
wherein the ionic stoichiometric activator is represented by the formula:

(Z)_{d}⁺A^{d-}

wherein (Z)_{d}⁺ is a cation, where Z is a reducible Lewis Acid; and A^{d-} is a non-coordinating anion having the charge d−, and d is 1, 2, or 3 (preferably (Z)_{d}⁺ is represented by the formula: (Ar₃C)⁺, where Ar is aryl or aryl substituted with a heteroatom, a C₁ to C₄₀ hydrocarbyl, or a substituted C₁ to C₄₀ hydrocarbyl) (preferably the ionic stoichiometric activator is selected from the group consisting of: triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, and triphenylcarbenium tetrakis(3,5-bis(trifluoromethyl)phenyl)borate);
(iii) contacting a metallocene compound comprising a group 4, 5, or 6 metal with the alkyl aluminum treated support material;
(iv) obtaining a supported metallocene catalyst system; and
(v) optionally, calcining the support material at a temperature in the range of from about 200° C. to about 850° C. (preferably from about 550° C. to about 650° C.) prior to contacting with the alkyl aluminum compound in step (i).
2. The process of paragraph 1, wherein the metallocene compound is represented by the formula:

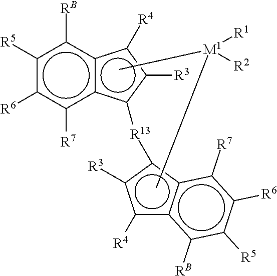

wherein:
M¹ is selected from titanium, zirconium, hafnium, vanadium, niobium, tantalum, chromium, molybdenum and tungsten (preferably M¹ is selected from titanium, zirconium, hafnium;
preferably M¹ is zirconium);
R¹ and R² are selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and substituted or unsubstituted C₇ to C₄₀ arylalkenyl groups; optionally R¹ and R² are joined together to form a C₄ to C₄₀ alkanediyl group or a conjugated C₄ to C₄₀ diene ligand which is coordinated to M¹ in a metallacyclopentene fashion; optionally R¹ and R² represent a conjugated diene, optionally substituted with one or more groups independently selected from hydrocarbyl, trihydrocarbylsilyl and trihydrocarbylsilylhydrocarbyl groups, said diene having a total of up to 40 atoms not counting hydrogen and forming a π complex with M¹ (preferably R¹ and R² are selected from chlorine, C₁ to C₆ alkyl groups, C₆ to C₁₀ aryl groups, C₇ to C₁₂ arylalkyl groups and C₇ to C₁₂ alkylaryl groups; more preferably R¹ and R² are methyl groups);
each R³ and R^{B} is independently selected from hydrogen, halogen, substituted or unsubstituted C₁ to C₁₀ alkyl groups, substituted or unsubstituted C₆ to C₁₄ aryl groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups, substituted or unsubstituted C₈ to C₄₀ arylalkenyl groups, and —NR′₂, —SR′, —OR′, —SiR′₃, —OSiR′₃, and —PR′₂ radicals wherein each R′ is independently selected from halogen, substituted or unsubstituted C₁ to C₁₀ alkyl groups and substituted or unsubstituted C₆ to C₁₄ aryl groups (preferably R³ is selected from C₃ to C₆ alkyl groups and phenyl; more preferably R³ is an isopropyl group);
R⁴, R⁵, R⁶, and R⁷ are each selected from the group consisting of hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and C₇ to C₄₀ substituted or unsubstituted arylalkenyl groups (preferably R⁴ is hydrogen or a C₁ to C₁₀ alkyl groups; preferably each of R⁵, R⁶, and R⁷ are substituted or unsubstituted C₁ to C₁₀ alkyl groups, preferably ethyl, isopropyl, alkoxy, amido, carbazoles or indoles; preferably R⁴, R⁵, R⁶, and R⁷ are each hydrogen); and
R¹³ is selected from:

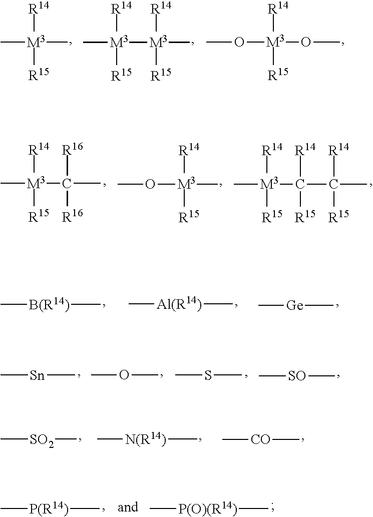

wherein:
R¹⁴, R¹⁵, and R¹⁶ are each independently selected from hydrogen, halogen, C₁ to C₂₀ alkyl groups, C₆ to C₃₀ aryl groups, C₁ to C₂₀ alkoxy groups, C₂ to C₂₀ alkenyl groups, C₇ to C₄₀ arylalkyl groups, C₈ to C₄₀ arylalkenyl groups and C₇ to C₄₀ alkylaryl groups, optionally R¹⁴ and R¹⁵, together with the atom(s) connecting them, form a ring; and
M³ is selected from carbon, silicon, germanium and tin; or
R¹³ is represented by the formula:

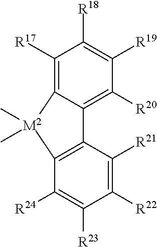

wherein:
R¹⁷, R¹⁸, R¹⁹, R²⁰, R²¹, R²², R²³, and R²⁴ are each independently selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ alkylaryl groups, substituted or unsubstituted C₇ to C₄₀ alkylaryl groups and substituted or unsubstituted C₈ to C₄₀ arylalkenyl groups; optionally two or more adjacent radicals R¹⁷, R¹⁸, R¹⁹, R²⁰, R²¹, R²², R²³, and R²⁴, including R²⁰ and R²¹, together with the atoms connecting them, form one or more rings; and
M² represents one or more carbon atoms, or a silicon, germanium or tin atom (preferably each R^{B} is hydrogen, R¹³ is Si(CH₃)₂, and M¹ is zirconium; alternately each R³ is methyl, each R^{B} is hydrogen, R¹³ is Si(CH₃)₂, and M¹ is zirconium; alternately each R^{B} is phenyl, each R³ is methyl, R¹³ is Si(CH₃)₂, and M¹ is zirconium).
3. The process of paragraphs 1 to 2, wherein the metallocene compound is represented by the formula:

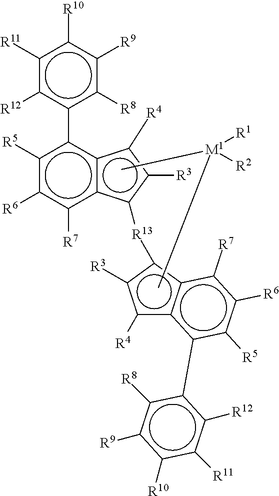

wherein:
M¹, R¹, R², R³, R⁴, R⁵, R⁶, R⁷, and R¹³ are as defined in paragraph 2;
R⁸, R⁹, R¹⁰, and R¹¹ are each independently selected from hydrogen, halogen, substituted or unsubstituted C₁ to C₁₀ alkyl groups, substituted or unsubstituted C₆ to C₁₄ aryl groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups, substituted or unsubstituted C₈ to C₄₀ arylalkenyl groups, and —NR′₂, —SR′, —OR′, —SiR′₃, —OSiR′₃, and —PR′₂ radicals wherein each R′ is as defined in paragraph 2; and
R¹² is selected from halogen, substituted or unsubstituted C₂ to C₁₀ alkyl groups, substituted or unsubstituted C₆ to C₁₄ aryl groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups, substituted or unsubstituted C₈ to C₄₀ arylalkenyl groups, and —NR′₂, —SR′, —OR′, —SiR′₃, —OSiR′₃, and —PR′₂ radicals, wherein each R′ is as defined in paragraph 2 (preferably R¹² is selected from substituted or unsubstituted C₁ to C₆ alkyl groups and substituted or unsubstituted C₆ to C₁₀ aryl groups; more preferably R¹² is phenyl) (preferably, R³ is selected from isopropyl, isobutyl, sec-butyl, tert-butyl and phenyl groups, and R¹² is selected from n-propyl, isopropyl, n-butyl, isobutyl, sec-butyl, tert-butyl, phenyl, tolyl, benzyl, and naphthyl groups).
4. The process of paragraphs 1 to 3, wherein the metallocene compound is represented by one or more of the formulae:

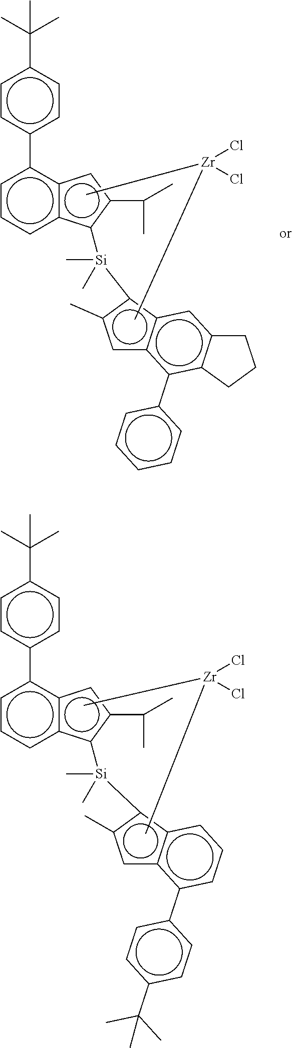

or the dimethyl analogs thereof
5. The process of paragraph 1, wherein the metallocene compound is one of:
dimethylsilanediylbis[2-t-butylmethyl-4-(1-naphthyl)-indenyl]zirconiumdichloride;
dimethylsilanediylbis[2-t-butylmethyl-4-(2-naphthyl)-indenyl]zirconiumdichloride;
dimethylsilanediylbis[2-t-butylmethyl-4-(4-methyl-phenyl)-indenyl]zirconiumdichloride;
dimethylsilanediylbis[2-t-butylmethyl-4-(4-biphenyl)-indenyl]zirconiumdichloride;
dimethylsilanediylbis[2-t-butylmethyl-4-(4-ethylphenyl)-indenyl]zirconiumdichloride;
dimethylsilanediylbis[2-t-butylmethyl-4-(4-n-propyl-phenyl)-indenyl]zirconiumdichloride;
dimethylsilanediylbis[2-t-butylmethyl-4-(4-i-propyl-phenyl)-indenyl]zirconiumdichloride;
dimethylsilanediylbis[2-t-butylmethyl-4-(4-t-butyl-phenyl)-indenyl]zirconiumdichloride;
dimethylsilanediylbis[2-t-butylmethyl-4-(4-sec-buty-1-phenyl)-indenyl]zirconiumdichloride;
dimethylsilanediylbis[2-t-butylmethyl-4-(4-cyclohexyl-phenyl)-indenyl]zirconiumdichloride;
dimethylsilanediylbis[2-t-butylmethyl-4-(4-trimethylsilylphenyl)indenyl]zirconiumdichloride;
dimethylsilanediylbis[2-t-butylmethyl-4-(4-adamantyl-phenyl)-indenyl]zirconiumdichloride;
dimethylsilanediylbis[2-t-butylmethyl-4-(3-biphenyl)-indenyl]zirconiumdichloride;
dimethylsilanediylbis[2-t-butylmethyl-4-(3,5-dimethyl-phenyl)-indenyl]zirconiumdichloride;
dimethylsilanediylbis[2-t-butylmethyl-4-(3,5-di(trifluoromethyl)phenyl)indenyl]zirconiumdichloride;
dimethylsilanediylbis[2-t-butylmethyl-4-(3,5-terphenyl)-indenyl]zirconiumdichloride;
dimethylsilanediylbis[2-cyclopentylmethyl-4-(1-naphthyl)-indenyl]zirconiumdichloride;
dimethylsilanediylbis[2-cyclopentylmethyl-4-(2-naphthyl)-indenyl]zirconiumdichloride;
dimethylsilanediylbis[2-cyclopentylmethyl-4-(4-methyl-phenyl)-indenyl]zirconiumdichloride;
dimethylsilanediylbis[2-cyclopentylmethyl-4-(4-biphenyl)-indenyl]zirconiumdichloride;
dimethylsilanediylbis[2-cyclopentylmethyl-4-(4-ethyl-phenyl)-indenyl]zirconiumdichloride;
dimethylsilanediylbis[2-cyclopentylmethyl-4-(4n-propyl-phenyl)indenyl]zirconiumdichloride; dimethylsilanediylbis[2-cyclopentylmethyl-4-(4i-propyl-phenyl)indenyl]zirconiumdichloride; dimethylsilanediylbis[2-cyclopentylmethyl-4-(4-t-butyl-phenyl)-indenyl]zirconiumdichloride;
dimethylsilanediylbis[2-cyclopentylmethyl-4-(4sec-butyl-phenyl)indenyl]zirconiumdichloride;
dimethylsilanediylbis[2-cyclopentylmethyl-4-(4cyclohexyl-phenyl)-indenyl]zirconiumdichloride;
dimethylsilanediylbis[2-cyclopentylmethyl-4-(4-trimethylsilyl-phenyl)-indenyl]zirconiumdichloride;
dimethylsilanediylbis[2-cyclopentylmethyl-4-(4 adamantyl-phenyl)-indenyl]zirconiumdichloride;
dimethylsilanediylbis[2-cyclopentylmethyl-4-(3-biphenyl)-indenyl]zirconiumdichloride;
dimethylsilanediylbis[2-cyclopentylmethyl-4-(3,5-dimethyl-phenyl)-indenyl]zirconiumdichloride;
dimethylsilanediylbis[2-cyclopentylmethyl-4-(3,5-di-(trifluoromethyl)-phenyl)-indenyl]zirconiumdichloride;
dimethylsilanediylbis[2-cyclopentylmethyl-4-(3,5-terphenyl)-indenyl]zirconiumdichloride;
dimethylsilanediylbis[2-cyclohexylmethyl-4-(1-naphthyl)-indenyl]zirconiumdichloride;
dimethylsilanediylbis[2-cyclohexylmethyl-4-(2naphthyl)-indenyl]zirconiumdichloride;
dimethylsilanediylbis[2-cyclohexylmethyl-4-(4-methyl-phenyl)-indenyl]zirconiumdichloride;
dimethylsilanediylbis[2-cyclohexylmethyl-4-(4-biphenyl)-indenyl]zirconiumdichloride;
dimethylsilanediylbis[2-cyclohexylmethyl-4-(4-ethyl-phenyl)-indenyl]zirconiumdichloride;
dimethylsilanediylbis[2-cyclohexylmethyl-4-(4-n-propylphenyl)-indenyl]zirconiumdichloride; dimethylsilanediylbis[2-cyclohexylmethyl-4-(4-i-propylphenyl)-indenyl]zirconiumdichloride; dimethylsilanediylbis[2-cyclohexylmethyl-4-(4-t-butyl-phenyl)-indenyl]zirconiumdichloride; dimethylsilanediylbis[2-cyclohexylmethyl-4-(4sec-butyl-phenyl)indenyl]zirconiumdichloride;
dimethylsilanediylbis[2-cyclohexylmethyl-4-(4-cyclohexyl-phenyl)-indenyl]zirconiumdichloride;
dimethylsilanediylbis[2-cyclohexylmethyl-4-(4-trimethylsilyl-phenyl)-indenyl]zirconiumdichloride;
dimethylsilanediylbis[2-cyclohexylmethyl-4-(4-adamantyl-phenyl)-indenyl]zirconiumdichloride, as well as the analogous zirconiumdimethyl and zirconium biphenolate and zirconium bisphenolate compounds;
dimethylsilanediylbis{1-[2-n-propyl,4-(2-methylphenyl)indenyl]}zirconiumdichloride;
dimethylsilanediylbis{1-[2-isopropyl,4-(2-methylphenyl)indenyl]}zirconiumdichloride;
dimethylsilanediylbis{1-[2-n-butyl,4-(2-methylphenyl)indenyl]}zirconiumdichloride;
dimethylsilanediylbis{1-[2-isobutyl,4-(2-methylphenyl)indenyl]}zirconiumdichloride;
dimethylsilanediylbis{1-[2-sec-butyl,4-(2-methylphenyl)indenyl]}zirconiumdichloride;
dimethylsilanediylbis{1-[2-tert-butyl,4-(2-methylphenyl)indenyl]}zirconiumdichloride;
dimethylsilanediylbis{1-[2-phenyl,4-(2-methylphenyl)indenyl]}zirconiumdichloride;
dimethylsilanediylbis{1-[2-n-propyl,4-(2-ethylphenyl)indenyl]}zirconiumdichloride;
dimethylsilanediylbis{1-[2-isopropyl,4-(2-ethylphenyl)indenyl]}zirconiumdichloride;
dimethylsilanediylbis{1-[2-n-butyl,4-(2-ethylphenyl)indenyl]}zirconiumdichloride;
dimethylsilanediylbis{1-[2-isobutyl,4-(2-ethylphenyl)indenyl]}zirconiumdichloride;
dimethylsilanediylbis{1-[2-sec-butyl,4-(2-ethylphenyl)indenyl]}zirconiumdichloride;
dimethylsilanediylbis{1-[2-tert-butyl,4-(2-ethylphenyl)indenyl]}zirconiumdichloride;
dimethylsilanediylbis{1-[2-phenyl,4-(2-ethylphenyl)indenyl]}zirconiumdichloride;
dimethylsilanediylbis{1-[2-n-propyl,4-(2-n-propylphenyl)indenyl]}zirconiumdichloride;
dimethylsilanediylbis{1-[2-isopropyl,4-(2-n-propylphenyl)indenyl])}zirconiumdichloride;
dimethylsilanediylbis{1-[2-n-butyl,4-(2-n-propylphenyl)indenyl]}zirconiumdichloride;
dimethylsilanediylbis{1-[2-isobutyl,4-(2-n-propylphenyl)indenyl]}zirconiumdichloride;
dimethylsilanediylbis{1-[2-sec-butyl,4-(2-n-propylphenyl)indenyl]}zirconiumdichloride;
dimethylsilanediylbis{1-[2-tert-butyl,4-(2-n-propylphenyl)indenyl]}zirconiumdichloride;
dimethylsilanediylbis{1-[2-phenyl,4-(2-n-propylphenyl)indenyl]}zirconiumdichloride;
dimethylsilanediylbis{1-[2-n-propyl,4-(2-isopropylphenyl)indenyl]}zirconiumdichloride;
dimethylsilanediylbis{1-[2-isopropyl,4-(2-isopropylphenyl)indenyl]}zirconiumdichloride;
dimethylsilanediylbis{1-[2-n-butyl,4-(2-isopropylphenyl)indenyl]}zirconiumdichloride;
dimethylsilanediylbis{1-[2-isobutyl,4-(2-isopropylphenyl)indenyl]}zirconiumdichloride;
dimethylsilanediylbis{1-[2-sec-butyl,4-(2-isopropylphenyl)indenyl]}zirconiumdichloride;
dimethylsilanediylbis{1-[2-tert-butyl,4-(2-isopropylphenyl)indenyl]}zirconiumdichloride;
dimethylsilanediylbis{1-[2-phenyl,4-(2-isopropylphenyl)indenyl]}zirconiumdichloride;
as well as the analogous zirconiumdimethyl compounds;
dimethylsilanediylbis(2-methylbenzindenyl)zirconiumdichloride;
dimethylsilanediylbis(2-methylindenyl)zirconiumdichloride;
dimethylsilanediylbis(2-methyl-4-(1-naphthyl)indenyl)zirconiumdichloride;
dimethylsilanediylbis(2-methyl-4-(2-naphthyl)indenyl)zirconiumdichloride;
dimethylsilanediylbis(2-methyl-4-phenylindenyl)zirconiumdichloride;
dimethylsilanediylbis(2-methyl-4-t-butylindenyl)zirconiumdichloride;
dimethylsilanediylbis(2-methyl-4-isopropylindenyl)zirconiumdichloride;
dimethylsilanediylbis(2-methyl-4-ethylindenyl)zirconiumdichloride;
dimethylsilanediylbis(2-methyl-4-acenaphthindenyl)zirconiumdichloride;
dimethylsilanediylbis(2,4-dimethylindenyl)zirconiumdichloride;
dimethylsilanediylbis(2-ethylindenyl)zirconiumdichloride;
dimethylsilanediylbis(2-ethyl-4-ethylindenyl)zirconiumdichloride;
dimethylsilanediylbis(2-ethyl-4-phenylindenyl)zirconiumdichloride
dimethylsilanediylbis(2-methyl-4,5-benzindenyl)zirconiumdichloride;
dimethylsilanediylbis(2-methyl-4,6-diisopropylindenyl)zirconiumdichloride;
dimethylsilanediylbis(2-methyl-4,5-diisopropylindenyl)zirconiumdichloride;
dimethylsilanediylbis(2,4,6-trimethylindenyl)zirconiumdichloride;
dimethylsilanediylbis(2,5,6-trimethylindenyl)zirconiumdichloride;
dimethylsilanediylbis(2,4,7-trimethylindenyl)zirconiumdichloride;
dimethylsilanediylbis(2-methyl-5-isobutylindenyl)zirconiumdichloride;
dimethylsilanediylbis(2-methyl-5-t-butylindenyl)zirconiumdichloride;
methyl(phenyl)silanediylbis(2-methyl-4-phenylindenyl)zirconiumdichloride;
methyl(phenyl)silanediylbis(2-methyl-4,6-diisopropylindenyl)zirconiumdichloride;
methyl(phenyl)silanediylbis(2-methyl-4-isopropylindenyl)zirconiumdichloride;
methyl(phenyl)silanediylbis(2-methyl-4,5-benzindenyl)zirconiumdichloride;
methyl(phenyl)silanediylbis(2-methyl-4,5-(methylbenzindenyl)zirconiumdichloride;
methyl(phenyl)silanediylbis(2-methyl-4,5(tetramethylbenzindenyl)zirconiumdichloride; as well as the analogous zirconiumdimethyl compounds.
   6. A supported metallocene catalyst system produced by the process of paragraphs 1 to 5, the catalyst system comprising:
   (i) a metallocene compound comprising a group 4, 5, or 6 metal;
   (ii) an ionic stoichiometric activator represented by the formula:

(Z)_{d}⁺A^{d-}

wherein (Z)_{d}⁺ is a cation, where Z is a reducible Lewis Acid; and A^{d-} is a non-coordinating anion having the charge d−, and d is 1, 2, or 3; and
(iii) an alkyl aluminum treated support material,
wherein the alkyl aluminum treated support material is the reaction product of a support material and an alkyl aluminum;
wherein the support material is selected from the group consisting of SiO₂, Al₂O₃, or SiO₂/Al₂O₃;
wherein the alkyl aluminum compound represented by the formula:

R₃Al

wherein each R group is, independently, a substituted or unsubstituted C₁ to C₁₂ alkyl group, Cl or F with the proviso that at least one R group is a C₁ to C₁₂ alkyl group;
wherein the supported metallocene catalyst system has a catalyst productivity of greater than 50 gpolymer/g (cat)/hour (preferably 500 or more gpolymer/g (cat)/hour, preferably 5000 or more gpolymer/g (cat)/hour, preferably 50,000 or more gpolymer/g (cat)/hour) (preferably the supported metallocene catalyst system comprises from about 0.05 wt % to about 2.0 wt % group 4, 5, or 6 metal, based on the total weight of the catalyst system, preferably the catalyst system comprises about from about 0.02 to about 0.08 mmol of aluminum per gram of supported metallocene catalyst system, more preferably from about 0.04 mmol to about 0.06 mmol of aluminum per gram of supported metallocene catalyst system).
7. A polymerization process comprising:
(i) contacting one or more C₂ to C₄₀ olefin comonomer (preferably propylene and/or ethylene and optionally C₄ to C₂₀ or C₄ to C₁₂ alpha olefin comonomer (preferably 1-butene, 1-hexene, 1-octene, 1-decene, and/or 1-dodecene; more preferably 1-butene, 1-hexene, and/or 1-octene)) with the supported metallocene catalyst system of paragraph 6 under polymerization conditions; and
(ii) obtaining a polyolefin.
8. The process of paragraph 7, wherein the supported metallocene catalyst system is contacted with propylene monomer to make polypropylene in a first stage (optionally, further comprising contacting the polypropylene with the same or different supported metallocene catalyst system in the presence of ethylene and, optionally, one or more C₃ to C₄₀ olefin monomers (preferably propylene, butene, hexene, octene, decene, dodecene, preferably propylene, butene, hexene, octene) to produce an impact copolymer in a second stage).
9. The polymerization process of paragraphs 7 and 8, wherein the polymerization process: 1) is conducted at a temperature greater than 30° C. (preferably greater than 50° C., preferably greater than 65° C., alternately less than 200° C., preferably less than 150° C., most preferred less than 140° C.); 2) is conducted at in the range of from about 0.35 MPa to about 10 MPa (preferably from about 0.45 MPa to about 6 MPa or preferably from about 0.5 MPa to about 4 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; preferably where aromatics are preferably present in the solvent at less than 1 wt %, preferably less than 0.5 wt %, preferably at 0 wt % based upon the weight of the solvents); 4) wherein the catalyst system used in the polymerization comprises less than 0.5 mol %, preferably 0 mol % alumoxane, alternately the alumoxane is present at a molar ratio of aluminum to transition metal less than 500:1, preferably less than 300:1, preferably less than 100:1, preferably less than 1:1; 5) the polymerization preferably occurs in one, two, three, four, or more reaction zones; 6) the productivity of the catalyst system is at least 50 gpolymer/g (cat)/hour (preferably 500 or more gpolymer/g (cat)/hour, preferably 5000 or more gpolymer/g (cat)/hour, preferably 50,000 or more gpolymer/g (cat)/hour); and 7) optionally, hydrogen is present in the polymerization reactor at a partial pressure of from 0.001 to 100 psig (0.007 to 690 kPa) (preferably from 0.001 to 50 psig (0.007 to 345 kPa), preferably from 0.01 to 25 psig (0.07 to 172 kPa), more preferably 0.1 to 10 psig (0.7 to 70 kPa)).
10. A polypropylene made by the process of paragraphs 7 to 9, having one or more of the following properties: (i) 0 wt % to 25 wt % (alternately from 0.5 wt % to 20 wt %, alternately from 1 wt % to 15 wt %, preferably from 3 wt % to 10 wt %, preferably less than 1 wt %, preferably 0 wt %) of one or more of C₂ to C₄₀ olefin monomer (preferably propylene and/or ethylene and optionally C₄ to C₂₀ or C₄ to C₁₂ alpha olefin comonomer (preferably 1-butene, 1-hexene, 1-octene, 1-decene, and/or 1-dodecene; more preferably 1-butene, 1-hexene, and/or 1-octene)); (ii) an Mw of 5,000 to 1,000,000 g/mol (preferably 25,000 to 750,000 g/mol, preferably 50,000 to 500,000 g/mol); (iii) an Mw/Mn of greater than 1 to 40 (alternately 1.2 to 20, alternately 1.3 to 10, alternately 1.4 to 5, 1.5 to 4, alternately 1.5 to 3); (iv) a melting point of 153° C. or greater (preferably 155° C. or greater, preferably 157° C. or greater, preferably 160° C. or greater, preferably 162° C. or greater; alternately 180° C. or less, 175° C. or less, 170° C. or less, 165° C. or less).
11. An impact copolymer made by the process of paragraphs 8 to 9.
12. A blend comprising the polypropylene of paragraph 10 or the impact copolymer of paragraph 11.
13. An article made from the polypropylene of paragraph 10 or the impact copolymer of paragraph 11 or the blend of paragraph 12 (preferably the article is a molded product, a film, a non-woven or a fiber; preferably an automotive part or diaper component, such as a backing film).

### EXAMPLES

### Materials

All reagents were obtained from Sigma Aldrich Chemical Co. (St. Louis, Mo.), unless otherwise stated. All liquid reagents were purged with nitrogen before use. All reactions were conducted under an inert nitrogen atmosphere, unless otherwise noted. All solvents were anhydrous, unless otherwise noted.

Triisobutyl aluminum (TIBAL), trimethyl aluminum (TMAL), trimethyl aluminum (TEAL) and tri n-octyl aluminum (TNOAL) were obtained from Akzo Nobel Chemicals, Inc. (Tarrytown, N.Y. ) and used without further purification. Methyl alumoxane (MAO, 30 wt % in toluene) is obtained from Albemarle (Baton Rouge, La.).

The metallocene compounds in Table 1 were used in the Examples below.

TABLE 1
Metallocene Compounds Used In Examples

| Metallocene | |
|---|---|
| Compound | Structure |
| W | rac-Me₂Si(2-methyl-4-phenyl-1-indenyl)₂ZrMe₂ |
| X | 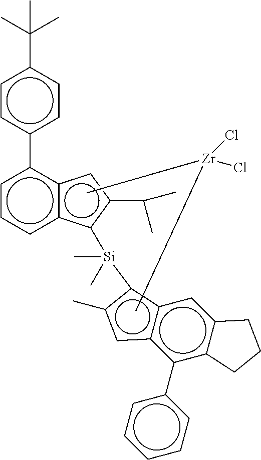 |
| Y | 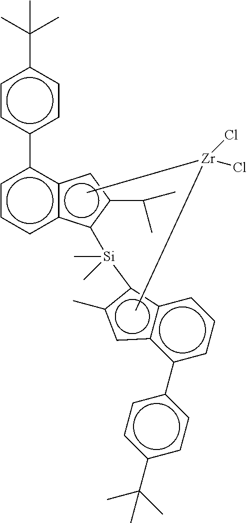 |
| Z | rac-dimethylsilanediylbis {1-[2-isopropyl, 4-(2- biphenylyl)indenyl)zirconiumdimethyl |

Metallocene W was synthesized as described in Organometallics 1994, 13, 954-963. Metallocenes X, Y, and Z were synthesized as described in U.S. Pat. No. 7,122,498.

### Test Methods:

### ¹H NMR

Reaction progress was monitored by ¹H NMR. Data was collected at room temperature in a 5 mm probe using a Varian spectrometer with a ¹H frequency of at least 250 MHz. Data was recorded using a maximum pulse width of 45° C., 8 seconds between pulses and signal averaging 120 transients.

### Polymer Preparation for GPC and FTIR

Polymer sample solutions were prepared by dissolving polymer in 1,2,4-trichlorobenzene (TCB, 99+% purity from Sigma-Aldrich) containing 2,6-di-tert-butyl-4-methylphenol (BHT, 99% from Aldrich) at 145° C. in a shaker oven for approximately 3 hours. The typical final concentration of polymer in solution was between 0.4 to 0.9 mg/mL with a BHT concentration of 1.25 mg BHT/mL of TCB. Samples were cooled to 135° C. for testing.

### GPC

Molecular weights (weight average molecular weight (Mw) and number average molecular weight (Mn)) and molecular weight distribution (MWD=Mw/Mn), were measured by Gel Permeation Chromatography (GPC) using a Symyx Technologies (now Accelerys Technologies, San Diego, Calif.) GPC equipped with evaporative light scattering detector and calibrated using polystyrene standards from Polymer Laboratories having an Mp (peak Mw) between 5000 and 3,390,000). Samples were run in TCB at (135° C. sample temperatures, 165° C. oven/columns) using three Polymer Laboratories PLgel 10m Mixed-B 300×7.5 mm columns in series. No column spreading corrections were employed. Numerical analyses were performed using EPOCH™ software available from Symyx Technologies.

### FTIR

FTIR analysis was performed on a FRA 106/s BRUKER Equinox 55 FTIR spectrometer. A sample (between 0.12 and 0.24 mg) diluted in TCB was deposited (8 ul) onto a salinized wafer and evaporated for 15 minutes at 145° C. The sample wafer was placed in the FTIR and loaded, and the tray equilibrated for 1 hour under a nitrogen purge. The EP integration area was 744.4-715.19, 780.892-776.403, 676-543-671.749. The wt % ethylene was determined by the measurement of the methylene rocking band (˜770 cm-1 to 700 cm-1). The peak area of the band was normalized by summing the band areas of the overtone bands in the 4500 cm-1 to 4000 cm-1 range. The normalized band area was then correlated to a calibration curve (derived from ¹³C NMR data) to predict the wt % ethylene within a concentration range of ˜5 to 40 wt %. Typically, R² correlations of 0.98 or greater were achieved.

### DSC

Melting temperature (Tₘ) and glass transition temperature (Tg) were measured using Differential Scanning calorimetry (DSC). Approximately 0.07 g of each polymer were weighed into tared glass vials. Each glass vial was then weighed and 2.8 ml of trichlorobenzene with BHT (butylated hydroxytoluene) was added to each vial using the RAPID GPC station to obtain 25 mg/ml polymer solutions. The polymers were then dissolved at 165° C. with agitation. The RAPID GPC station then automatically dispensed approximately 0.4 ml of each 25 mg/ml polymer solution into DSC pans. The trichlorobenzene was evaporated at 165° C., over approximately 15 minutes. The DSC pans were then annealed in an oven purged with nitrogen at 220° C. (first melt) for 15 minutes and allowed to cool overnight to room temperature.

The DSC pans were loaded into the TA Instruments Q100 DSC at room temperature. The sample was equilibrated at 25° C., then heated at a heating rate 10 degree/min to 220° C. (second melt). The sample was held at a temperature of 220° C. for one minute and then cooled at a rate of 50° C./min to a temperature of 40° C.

The endothermic melting transition, if present, is analyzed for onset of transition and peak temperature. The melting temperatures reported are the peak melting temperatures from the first heat unless otherwise specified. For samples displaying multiple peaks, the melting point (or melting temperature) was defined to be the peak melting temperature (i.e., associated with the largest endothermic calorimetric response in that range of temperatures) from the DSC melting trace. First and second melts are reported in this Example Section. For the purpose of the claims, the melting temperature is second melt.

### MFR

Melt flow rate (MFR) was measured according to ASTM D 1238, condition L, at 230° C. and 2.16 kg load using a melt indexer.

### Example 1

### Synthesis of Supported Metallocene Catalyst Systems A to G

Trimethyl Aluminum Treated Silica (s-TMAL)

In a 200 mL flask, 16.3819 g of calcined silica (DAVIDSON™ 948, calcined at 600° C. for 24 hrs) was slurried in toluene and 0.727 g of AlMe₃ (TMAL) was added and the slurry heated to 80° C. and stirred. The reaction progress was monitored via ¹H NMR by taking aliquots of the solution and checking for the appearance of methyl peaks from excess AlMe₃. After 1 hour and 20 minutes, an additional 0.20 g of AlMe₃ was added, and the mixture was stirred for another 15 minutes at 80° C. Another 0.636 g of AlMe₃ was then added and the mixture was stirred for an additional 30 minutes. Finally, 1.14 g of AlMe₃ was then added and the mixture was allowed to stir for 40 minutes, and completion of the reaction was noted via presence of excess AlMe₃ in the solution by ¹H NMR. The slurry was then filtered and the white solid washed with toluene and allowed to dry overnight, yielding 17.1 g of a white solid (s-TMAL).

Triethyl Aluminum Treated Silica (s-TEAL)

In a 100 mL Celstir flask, 5.1724 g of calcined silica (DAVIDSON™ 948, calcined at 600° C. for 24 hours) was slurried in toluene and 1.1501 g of AlEt₃ (TEAL) was added and the slurry heated to 80° C. and stirred. The reaction progress was monitored via ¹H NMR by taking aliquots of the solution and checking for the appearance of ethyl peaks from excess AlEt₃. After 1 hour completion of the reaction was noted via presence of excess AlEt₃ in the solution by ¹H NMR. The slurry was then filtered and the white solid washed with toluene and allowed to dry overnight, yielding 5.5462 g of a white solid (s-TEAL).

Triisobutyl Aluminum Treated Silica (s-TIBAL)

In a 200 mL Celstir flask, 13.5576 g of calcined silica (DAVIDSON™ 948, calcined at 600° C. for 24 hrs) was slurried in 100 mL of toluene. To this was added 2.4068 g of TIBAL (triisobutyl aluminum). Gas evolution was observed upon first addition of the TIBAL. The slurry was heated to 65° C. for 20 minutes and then an aliquot was taken for a ¹H NMR, which showed the reaction to be incomplete. An additional 2.08 g of TIBAL was then added, and the progress of the reaction monitored by ¹H NMR after 20 minutes and again after another 35 minutes, both spectra showing completion. The slurry was filtered, washed with toluene, and allowed to dry under vacuum overnight, to yield 14.7996 g of a white solid (s-TIBAL).

Methylalumoxane Treated Silica (s-MAO)

In a 500 mL Celstir flask, 41.2472 g of calcined silica (DAVIDSON™ 948, calcined at 600° C. for 24 hrs) was slurried in 150 mL of toluene. To this was added 66.0 g of 30% by weight solution of MAO (methylalumoxane) in toluene. The slurry was heated to 80° C. for 1 hr and then an aliquot was taken for a ¹H NMR, which showed excess MAO. The slurry was filtered, washed with toluene, and allowed to dry under vacuum yielding 59.75 g of a white solid (s-MAO).

Comparative Catalyst System 1 (Metallocene W+MAO+s-MAO)

In a 20 mL vial, Metallocene W (23 mg, 0.039 mmol) and MAO (0.285 g of a 30 wt % solution, 0.0855 g MAO, 1.47 mmol) were combined and diluted in 6 mL of toluene to provide an orange solution. The solution was then added to s-MAO (1.0007 g) slurried in 16 mL of toluene. The resulting orange slurry was stirred for 1 hour, during which the solution turned slightly red. The solution was filtered to give an orange solid residue. The solid residue was dried under vacuum overnight, giving 0.9033 g of a pink solid (Comparative Catalyst System 1).

Catalyst System a ((Trityl Compound+Metallocene W)+s-TEAL)

In a 20 mL vial, 31.3 mg of triphenylmethyl tetrakis(perfluorophenyl)borate was combined with 20.0 mg of Metallocene W along with 1 mL of toluene. This was added to 1.00 g of dry s-TEAL along with an additional 3 mL of toluene, in a 50 mL round bottom flask. 25 mL of pentane was then added and the solid filtered under vacuum, giving a clear filtrate and a tan solid. An additional 2 mL of toluene was used to wash the solid, giving a colored filtrate. The solid was dried under vacuum, to provide Catalyst System A as 0.9279 g of a purple solid.

Catalyst System B ((Trityl Compound+Metallocene W)+s-TMAL)

In a 20 mL vial, 35.2 mg of triphenylmethyl tetrakis(perfluorophenyl)borate and 22.5 mg of Metallocene W were combined together with 2 mL of toluene and the mixture was allowed to stir for 1 hour. To the resulting dark red-brown solution, 1.00 g of s-TMAL was added, and the mixture stirred with a spatula until homogeneous in color. The solid was then dried under vacuum overnight to provide Catalyst System B as a pink solid (1.02 g).

Catalyst System C ((Trityl Compound+Metallocene W)+s-TIBAL)

In a 20 mL vial, 34.7 mg triphenylmethyl tetrakis(perfluorophenyl)borate and 22.1 mg of rac-Me₂Si(2-methyl-4-phenyl-1-indenyl)₂ZrMe₂ were combined with 2.5 mL of toluene and the mixture was allowed to stir for 1 hour and 15 minutes, producing a dark red-brown solution. 1.00 g of STIBAL is added to the mixture and mixed together to give a homogenous color. The mixture was dried under vacuum to provide Catalyst System C as a purple solid (1.0193 g).

Catalyst System D ((Trityl Compound+Metallocene Y)+s-TMAL)

In a 20 mL vial, 36.1 mg of triphenylmethyl tetrakis(perfluorophenyl)borate and 28.5 mg of Metallocene Y were combined together with 2.5 mL of toluene and allowed to stir for 1 hr. The resulting dark red/purple solution was added to 1.00 g s-TMAL in a 100 mL flask and mixed together with a spatula until the mixture was homogeneous in color. The solid was then dried under vacuum overnight to provide Catalyst System D as a dark pink solid (1.03 g).

Catalyst System E ((Trityl Compound+Metallocene X)+s-TIBAL)

In a 20 mL vial, 35.4 mg triphenylmethyl tetrakis(perfluorophenyl)borate and 27.4 mg of Metallocene X were combined along with 2.5 mL of toluene and allowed to stir for 50 min, producing a dark red-brown solution. 0.9810 g s-TIBAL was added to the mixture and mixed to provide a mixture that was homogeneous in color. The mixture was dried under vacuum to provide Catalyst System E as a purple solid (1.0815 g).

Catalyst System F ((Trityl Compound+Metallocene Z)+s-TEAL)

In a 20 mL vial, 35 mg of trityl tetrakis(perfluorophenyl)borate was combined with 30 mg of Metallocene Z and 1 mL of toluene. This combination was added to 1.007 g of s-TEAL, along with an additional 1 mL of toluene, in a 20 mL vial. The solvent was then removed under vacuum to yield Catalyst System F as a pale purple solid (1.015 g).

Catalyst System G ((Trityl Compound+Metallocene X)+s-TMAL)

In a 20 mL vial, 35.6 mg of triphenylmethyl tetrakis(perfluorophenyl)borate and 27.3 mg of Metallocene X were combined together, along with 2.5 mL of toluene. The mixture was allowed to stir for 45 minutes, resulting in a dark purple solution. 1.000 g of s-TMAL was added and the mixture mixed until homogeneous in color. The solid was then dried under vacuum to yield Catalyst System G as a pink solid (0.986 g).

Catalyst System H (Metallocene W+(Trityl Compound+s-TEAL))

Trityl tetrakis(perfluorophenyl)borate (30.2 mgs) was combined with s-TEAL (1.0001 g) in 10 mls of deuterated benzene in a 100 ml Celstir flask. The slurry was allowed to sit overnight during which the slurry silica particles became opaque. The silica was filtered, rinsed with several 3 ml portions of deuterated benzene and then reslurried into 10 mLs of deuterated benzene. 20.5 mgs of Metallocene W was added to the slurry. After five hours, the supported catalyst was filtered and dried under vacuum to yield 0.9097 g of Catalyst System H as a brown solid.

Catalyst System I (Trityl Compound+s-TEAL)+Metallocene W

s-TEAL (2.4909 g) was slurried in 20 mL of toluene. Trityl tetrakis(perfluorophenyl) borate (74.8 mg) was added to the slurry and stirred overnight. The slurry was observed to be mostly white with a small streak of yellow on the side of the flask. The yellow streak was washed down and the slurry became a yellow color. The slurry was allowed to stir for another 30 minutes before it was filtered and washed with 3×7 mL of toluene. The solid was dried under vacuum for 1 hour and 20 minutes. 1.0475 g of the partially dried solid was separated out in a first crop. The remainder of the solid was further dried under vacuum, and consolidated with the first crop, to give a total yield of 1.8232 g of light yellow-gray solid.

0.5009 g of this light yellow-gray solid was slurried in 10 mL of toluene. Metallocene W (10.3 mg) was added to the slurry and stirred for 4 hours and 20 minutes. The slurry was then filtered, washed with 3×7 mL of toluene and dried under vacuum to yield 0.4565 g of Catalyst System I as a yellow solid.

### Example 2

### Polymerizations Using Supported Metallocene Catalyst Systems A to E

In the following slurry phase examples, pressure is reported in atmospheres and pounds per square inch.

Feed/Solvent Polymerization grade propylene was used and further purified by passing it through a series of columns: 2250 cc column packed with dried 3 Å mole sieves (Aldrich Chemical Company), followed 500 cc column of Almatis AC, Inc. SELEXSORB™ COS (activated alumina beads (7×14 mesh)), followed by 2 500 cc Oxyclear cylinder from Labelear (Oakland, Calif.).

Polymerization grade hexanes was used and further purified by passing it through a series of columns: 500 cc OXYCLEAR™ cylinder from Labelear (Oakland, Calif.) followed by a 500 cc column packed with dried 3A mole sieves purchased from Aldrich Chemical Company, and a 500 cc column packed with dried 5 Å mole sieves also purchased from Aldrich Chemical Company.

### Reactor Description and Preparation

Polymerizations were conducted in an inert atmosphere (N₂) drybox using autoclaves equipped with an external heater for temperature control, glass inserts (internal volume of reactor=22.5 mL), septum inlets, regulated supply of nitrogen, propylene, and equipped with disposable PEEK mechanical stirrers (800 RPM). The autoclaves were prepared by purging with dry nitrogen at 110° C. for 5 hours and then at 25° C. for 5 hours. In some polymerizations 1 atm of hydrogen was added.

### Propylene Polymerizations/Ethylene-Propylene Polymerizations

### General Description

The reactor was prepared as described above, and then purged with propylene. The use of a heated stir tops and manifolds were employed to prevent propylene from refluxing. The reactors were heated to 40° C. and 1 ml propylene was first charged to each reactor via syringe. Ethylene was added to the reactor to the desired pressure.

A solution of scavenger or co-activator (80 microliters of a 0.05 M tri-n-octylaluminum solution) at room temperature and pressure was next added to the reactors via syringe. The reactors were then brought to process temperature (70° C.) while stirring at 800 RPM.

Supported catalysts (0.39 mgs) were stirred in toluene at ambient temperature and pressure and added to the reactors (at process temperature and pressure) via syringe as slurry to initiate polymerization.

Where slurries or solutions are added via syringe, isohexane (3.77 mls) was also injected via the same syringe following their addition to flush any remaining slurry or solution into the reactors. This procedure is applied after the addition of the cocatalyst solution as well as the catalyst slurry.

Reactor pressure was allowed to drop during the polymerization. Reactor temperature was monitored and typically maintained within +/−1° C. Polymerizations were quenched by addition of approximately 50 psig delta of Ultra Zero Air gas to the autoclaves for approximately 30 seconds. The reactors were cooled and vented.

The polymer was isolated after the remaining reaction components were removed in-vacuo. Yields reported include total weight of polymer and any residual catalyst. Process conditions for each run are reported in Table 2, below.

TABLE 2
Process Parameters Using Metallocene Catalyst Systems A to E

| | Catalyst | Ethylene | Ethylene, | H₂, | Run | | Productivity |
|---|---|---|---|---|---|---|---|
| Run # | System | Pressure (psi) | Wt % | atm | Time, s | Yield, g | gP/gcat/hr |
| 1 | Comparative 1: | 0 | 0 | 1 | 1802 | 0.204 | 1045 |
| 2 | Metallocene W + | 0 | 0 | — | 2701 | 0.067 | 230 |
| 3 | MAO + s-MAO | 20 | 9.68 | — | 2701 | 0.074 | 253 |
| 4 | | 40 | 10.2 | — | 2703 | 0.106 | 363 |
| 5 | | 80 | 16.8 | — | 2430 | 0.097 | 371 |
| 6 | | 120 | 30.4 | — | 1636 | 0.105 | 591 |
| 7 | | 160 | 36.9 | — | 1407 | 0.103 | 678 |
| 8 | A: | 0 | 0 | 0 | 1801 | 0.073 | 376 |
| | Metallocene W + | | | | | | |
| | Ph₃CB(C6F5)₄ + | | | | | | |
| | s-TEAL | | | | | | |
| 9 | B: | 0 | 0 | 1 | 2701 | 0.030 | 103 |
| 10 | Metallocene W + | 0 | 0 | 1 | 2703 | 0.037 | 128 |
| 11 | Ph₃CB(C6F5)₄ + | 40 | 19.4 | — | 2702 | 0.02 | 68.3 |
| 12 | s-TMAL | 80 | 49.5 | — | 2702 | 0.043 | 146 |
| 13 | | 120 | 43.3 | — | 2701 | 0.043 | 147 |
| 14 | | — | — | — | — | — | — |
| 15 | | 160 | 55.1 | — | 2701 | 0.041 | 140 |
| 16 | | — | — | | — | — | — |
| 17 | C: | 0 | 0 | 1 | 175.7 | 0.275 | 1443 |
| 18 | Metallocene W + | 0 | 0 | 1 | 2433 | 0.157 | 594 |
| 19 | Ph₃CB(C6F5)₄ + | 40 | 11.3 | — | 50.7 | 0.320 | 5829 |
| 20 | s-TIBAL | 80 | 20.1 | — | 63.5 | 0.328 | 4769 |
| 21 | | 120 | 26.9 | — | 36.5 | 0.381 | 9625 |
| 22 | | 160 | 35.7 | — | 35.9 | 0.391 | 1005 |
| 23 | D: | 0 | 0 | 1 | 184 | 0.171 | 8592 |
| 24 | Metallocene Y + | 0 | 0 | 1 | 351 | 0.168 | 4414 |
| 25 | Ph₃CB(C6F5)₄ + | 40 | 13.9 | — | 292 | 0.164 | 5183 |
| 26 | s-TMAL | 80 | 20.5 | — | 303 | 0.165 | 5027 |
| 27 | | 120 | 29.4 | — | 278 | 0.139 | 4610 |
| 28 | | 160 | 35.8 | | 188 | .135 | 6655 |
| 29 | E: | | 0 | 1 | 2700 | 0.0116 | 40 |
| 30 | Metallocene X + | | 0 | 1 | 2702 | 0.051 | 173 |
| 31 | Ph₃CB(C6F5)₄ + | 40 | 13.5 | — | 2192 | 0.13 | 547 |
| 32 | s-TIBAL | 80 | 22.9 | — | 2163 | 0.117 | 500 |
| 33 | | 120 | 32 | — | 935 | 0.116 | 1142 |
| 34 | | 160 | 41.6 | — | 1312 | 0.104 | 734 |

The polymers characterized by GPC and DSC, and the results are presented in Table 3, below.

TABLE 3
Characterization of Polymers Produced By Runs 1 to 34

| | | | | | Tm |
|---|---|---|---|---|---|
| | Catalyst | Mn, | Mw, | | (first melt) |
| Run # | System | kg/mol | kg/mol | MWD | ° C. |
| 1 | Comparative 1: | 79.5 | 145.0 | 1.82 | 152 |
| 2 | Metallocene W + | 469.7 | 1,000.4 | 2.14 | — |
| 3 | MAO + s-MAO | 90.7 | 204.9 | 2.26 | — |
| 4 | | 63.4 | 126.8 | 2.0 | — |
| 5 | | 63.8 | 119.8 | 1.88 | — |
| 6 | | 72.5 | 125.7 | 1.73 | — |
| 7 | | 81.7 | 140.4 | 1.72 | — |
| 8 | A: | 160.3 | 306.9 | 1.91 | 156 |
| | Metallocene W + | | | | |
| | Ph₃CB(C6F5)₄ + | | | | |
| | s-TEAL | | | | |
| 9 | B: | 30.0 | 65.9 | 2.19 | 155 |
| 10 | Metallocene W + | 35.8 | 77.7 | 2.17 | 155 |
| 11 | Ph₃CB(C6F5)₄ + | 79.30 | 145.0 | 1.83 | — |
| 12 | s-TMAL | 59.25 | 163.0 | 2.75 | — |
| 13 | | 58.90 | 181.9 | 3.09 | — |
| 14 | | 62.69 | 117.1 | 1.87 | — |
| 15 | | 63.28 | 229.5 | 3.63 | — |
| 16 | | 67.10 | 127.3 | 1.9 | — |
| 17 | C: | 140.67 | 253.7 | 1.8 | 158 |
| 18 | Metallocene W + | 89.51 | 192.4 | 2.15 | 156 |
| 19 | Ph₃CB(C6F5)₄ + | 45.1 | 89.9 | 1.99 | — |
| 20 | s-TIBAL | 54.53 | 99.40 | 1.82 | — |
| 21 | | 37.64 | 85.26 | 2.27 | — |
| 22 | | 43.6 | 95.95 | 2.20 | — |
| 23 | D: | 12.90 | 20.67 | 1.6 | 149 |
| 24 | Metallocene Y + | 138.5 | 22.39 | 1.62 | 150 |
| 25 | Ph₃CB(C6F5)₄ + | 55.25 | 86.93 | 1.57 | — |
| 26 | s-TMAL | 77.05 | 122.38 | 1.59 | — |
| 27 | | 108.91 | 175.25 | 1.61 | — |
| 28 | | 149.01 | 237.24 | 1.59 | |
| 29 | E: | 13.37 | 25.02 | 1.87 | 150 |
| 30 | Metallocene X + | 42.47 | 72.28 | 1.7 | 153 |
| 31 | Ph₃CB(C6F5)₄ + | 134.52 | 217.78 | 1.62 | — |
| 32 | s-TIBAL | 202.26 | 329.66 | 1.63 | — |
| 33 | | 260.56 | 427.73 | 1.64 | — |
| 34 | | 347.07 | 568.32 | 1.64 | — |

### Example 3

### Polymerizations Using Supported Metallocene Catalyst Systems E & F

### General Description:

A 1 gram amount of supported metallocene catalyst system was slurried into dry HYDROBRITE™ oil to yield a slurry that contains 5 wt % catalyst. Into a 2 L stainless steel autoclave reactor was added 50 microliters of TNOAL followed by 1250 mls of propylene. The reactor was heated to 70° C. with the stirring rate set at 750 rpm. The supported metallocene catalyst system slurry was then added. The polymerization was allowed to proceed for one hour at which time the reactor was cooled and excess pressure vented. The solid resin was transferred into a glass vessel and dried at 80° C. in a vacuum oven for at least 2 hours. The process conditions, yields and polymer characterization are presented in Table 4, below.

TABLE 4
Process Parameters & Polypropylene Characterization

| Catalyst System | F | F | E | E |
|---|---|---|---|---|
| Run Time, min | 60 | 60 | 60 | 60 |
| Catalyst Loading, g | 0.208 | 0.206 | 0.205 | 0.205 |
| Yield, g | 30.4 | 42.5 | 48 | 67 |
| H₂, psi | 4 | 0 | 4 | 4 |
| Tm 2^{nd} melt, ° C. | 158 | 158 | 158 | 159 |
| Mn, g/mol | — | 64,052 | 62,194 | 91,578 |
| Mw, g/mol | — | 196,317 | 186,701 | 219,190 |
| MWD | — | 3.06 | 3.00 | 2 |
| MFR, g/10 min | — | 47 | — | 41 |

### Example 4

### Polymerizations Using Supported Metallocene Catalyst Systems H & I

### General Description

Into a 2 L stainless steel autoclave reactor was added TNOAL (2 mL of 0.091M solution in hexane) followed by 20 psi of H₂, and then 600 mls of propylene. The reactor is heated to 70° C. with a stir rate set at 500 rpm The supported metallocene catalyst system slurry was then added into the reactor using a catalyst tube. The catalyst tube was rinsed into the reactor with an additional 200 mL of propylene. The polymerization was allowed to proceed for one hour at which time the reactor was cooled and excess pressure vented. The solid resin was transferred into a glass vessel and dried at 80° C. in a vacuum oven for at least 2 hours. The process conditions, yields and polymer characterization are presented in Table 5, below.

TABLE 5
Process Parameters

| Catalyst System | H | H | I | I |
|---|---|---|---|---|
| Run Time, min | 22 | 60 | 60 | 60 |
| Catalyst Loading, g | 0.0605 | 0.042 | 0.0614 | 0.0694 |
| Yield, g | 11.30 | 66.82 | 3.31 | 2.62 |

All documents described herein are incorporated by reference herein, including any priority documents and/or testing procedures to the extent they are not inconsistent with this text, provided however that any priority document not named in the initially filed application or filing documents is NOT incorporated by reference herein. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law. Likewise, “comprising” encompasses the terms “consisting essentially of,” “is,” and “consisting of” and anyplace “comprising” is used “consisting essentially of,” “is,” or “consisting of” may be substituted therefor.

What is claimed is:

1. A process to produce a supported metallocene catalyst system, the process comprising:
(i) contacting a support material with an alkyl aluminum compound to provide an alkyl aluminum treated support material;
wherein the alkyl aluminum compound is represented by the formula:
R₃Al;
wherein each R group is, independently, a substituted or unsubstituted C₁ to C₁₂ alkyl group, Cl or F with the proviso that at least one R group is a C₁ to C₁₂ alkyl group;
(ii) contacting the alkyl aluminum treated support material with an ionic stoichiometric activator,
wherein the ionic stoichiometric activator is represented by the formula:
(Z)_{d}⁺A^{d-}
wherein (Z)_{d}⁺ is a cation, A^{d-} is a non-coordinating anion having the charge d−, and d is 1, 2, or 3, and (Z)_{d}⁺ is represented by the formula: (Ar₃C)⁺, where Ar is aryl or aryl substituted with a heteroatom, a C₁ to C₄₀ hydrocarbyl, or a substituted C₁ to C₄₀ hydrocarbyl;
(iii) contacting a metallocene compound comprising a group 4, 5, or 6 metal with the alkyl aluminum treated support material; and
(iv) obtaining a supported metallocene catalyst system.

2. The process of claim 1, wherein the support material is SiO₂, Al₂O₃, or SiO₂/Al₂O₃.

3. The process of claim 1, further comprising calcining the support material at a temperature in the range of from about 200° C. to about 850° C. prior to contacting with the alkyl aluminum compound in step (i).

4. The process of claim 3, wherein the support material is calcined to a temperature of from about 550° C. to about 650° C.

5. The process of claim 1, wherein the alkyl aluminum compound is one or more of trimethyl aluminum, triethyl aluminum, tri-n-octyl aluminum, tri-isobutyl aluminum, tri-n-hexyl aluminum, and dimethyl aluminum fluoride.

6. The process of claim 1, wherein Ar is aryl or aryl substituted with a heteroatom.

7. The process of claim 1, wherein the ionic stoichiometric activator is selected from the group consisting of: triphenylcarbenium tetraphenylborate, triphenylcarbenium tetrakis(pentafluorophenyl)borate, triphenylcarbenium tetrakis-(2,3,4,6-tetrafluorophenyl) borate, triphenylcarbenium tetrakis(perfluoronaphthyl)borate, triphenylcarbenium tetrakis(perfluorobiphenyl)borate, and triphenylcarbenium tetrakis(3,5-bis(trifluoromethyl)phenyl)borate.

8. The process of claim 1, wherein the metallocene compound is represented by the formula: 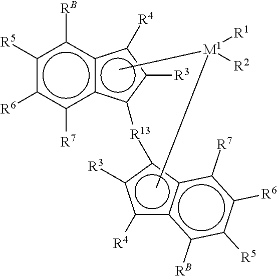
wherein:
M¹ is selected from titanium, zirconium, hafnium, vanadium, niobium, tantalum, chromium, molybdenum and tungsten;
R¹ and R² are selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and substituted or unsubstituted C₇ to C₄₀ arylalkenyl groups; optionally, R¹ and R² are joined together to form a C₄ to C₄₀ alkanediyl group or a conjugated C₄ to C₄₀ diene ligand which is coordinated to M¹ in a metallacyclopentene fashion; optionally, R¹ and R² represent a conjugated diene, optionally, substituted with one or more groups independently selected from hydrocarbyl, trihydrocarbylsilyl and trihydrocarbylsilylhydrocarbyl groups, said diene having a total of up to 40 atoms not counting hydrogen and forming a π complex with M¹;
each R³ and R^{B} is independently selected from hydrogen, halogen, substituted or unsubstituted C₁ to C₁₀ alkyl groups, substituted or unsubstituted C₆ to C₁₄ aryl groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups, substituted or unsubstituted C₈ to C₄₀ arylalkenyl groups, and —NR′₂, —SR′, —OR′, —SiR′₃, —OSiR′₃, and —PR′₂ radicals wherein each R′ is independently selected from halogen, substituted or unsubstituted C₁ to C₁₀ alkyl groups and substituted or unsubstituted C₆ to C₁₄ aryl groups;
R⁴, R⁵, R⁶, and R⁷ are each selected from the group consisting of hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and C₇ to C₄₀ substituted or unsubstituted arylalkenyl groups; and
R¹³ is selected from: 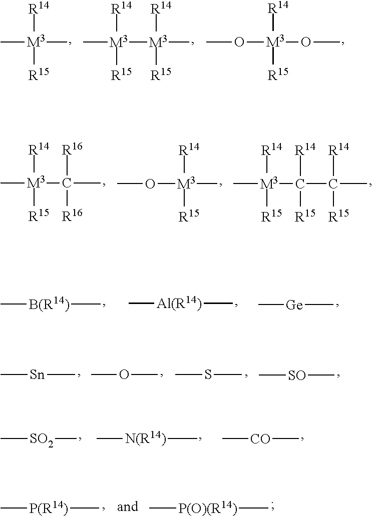
wherein:
R¹⁴, R¹⁵, and R¹⁶ are each independently selected from hydrogen, halogen, C₁ to C₂₀ alkyl groups, C₆ to C₃₀ aryl groups, C₁ to C₂₀ alkoxy groups, C₂ to C₂₀ alkenyl groups, C₇ to C₄₀ arylalkyl groups, C₈ to C₄₀ arylalkenyl groups and C₇ to C₄₀ alkylaryl groups, optionally R¹⁴ and R¹⁵, together with the atom(s) connecting them, form a ring; and
M³ is selected from carbon, silicon, germanium, and tin; or
R¹³ is represented by the formula: 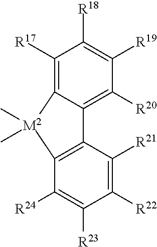
wherein:
R¹⁷, R¹⁸, R¹⁹, R²⁰, R²¹, R²², R²³, and R²⁴ are each independently selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ alkylaryl groups, substituted or unsubstituted C₇ to C₄₀ alkylaryl groups and substituted or unsubstituted C₈ to C₄₀ arylalkenyl groups; optionally, two or more adjacent radicals R¹⁷, R¹⁸, R¹⁹, R²⁰, R²¹, R²², R²³, and R²⁴, including R²⁰ and R²¹, together with the atoms connecting them, form one or more rings; and
M² represents one or more carbon atoms, or a silicon, germanium, or tin atom.

9. The process of claim 8, where M¹ is zirconium.

10. The process of claim 8, wherein R¹ and R² are independently from chlorine, C₁ to C₆ alkyl groups, C₆ to C₁₀ aryl groups, C₇ to C₁₂ arylalkyl groups and C₇ to C₁₂ alkylaryl groups.

11. The process of claim 8, wherein R¹ and R² are methyl groups.

12. The process of claim 8, wherein each R³ is independently is selected from C₃ to C₆ alkyl groups and phenyl.

13. The process of claim 8, wherein at least one R³ is an isopropyl group.

14. The process of claim 8, wherein each R^{B} is hydrogen, R¹³ is Si(CH₃)₂, and M¹ is zirconium.

15. The process of claim 8, wherein each R³ is methyl, each R^{B} is hydrogen, R¹³ is Si(CH₃)₂, and M¹ is zirconium.

16. The process of claim 8, wherein each R^{B} is phenyl, each R³ is methyl, R¹³ is Si(CH₃)₂, and M¹ is zirconium.

17. The process of claim 8, wherein the metallocene compound is represented by the formula: 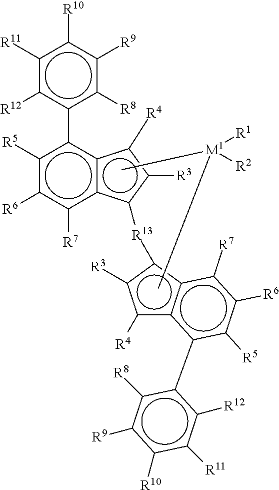
wherein:
M¹; R¹ and R²; R³; R⁴, R⁵, R⁶, R⁷, and R¹³ are as defined in claim 8;
R⁸, R⁹, R¹⁰, and R¹¹ are each independently selected from hydrogen, halogen, substituted or unsubstituted C₁ to C₁₀ alkyl groups, substituted or unsubstituted C₆ to C₁₄ aryl groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups, substituted or unsubstituted C₈ to C₄₀ arylalkenyl groups, and —NR′₂, —SR′, —OR′, —SiR′₃, —OSiR′₃, and —PR′₂ radicals wherein each R′ is as defined in claim 8; and
R¹² is selected from halogen, substituted or unsubstituted C₂ to C₁₀ alkyl groups, substituted or unsubstituted C₆ to C₁₄ aryl groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups, substituted or unsubstituted C₈ to C₄₀ arylalkenyl groups, and —NR′₂, —SR′, —OR′, —SiR′₃, —OSiR′₃, and —PR′₂ radicals, wherein each R′ is as defined in claim 8.

18. The process of claim 17, wherein each R¹² is independently selected from C₁ to C₆ alkyl groups and C₆ to C₁₀ aryl groups.

19. The process of claim 17, wherein at least one R¹² is phenyl.

20. The process of claim 17, wherein each R³ is independently selected from isopropyl, isobutyl, sec-butyl, tert-butyl, and phenyl groups, and each R¹² is independently selected from n-propyl, isopropyl, n-butyl, isobutyl, sec-butyl, tert-butyl, phenyl, tolyl, benzyl, and naphthyl groups.

21. The process of claim 17, wherein the metallocene compound is represented by one or more of the formulae: 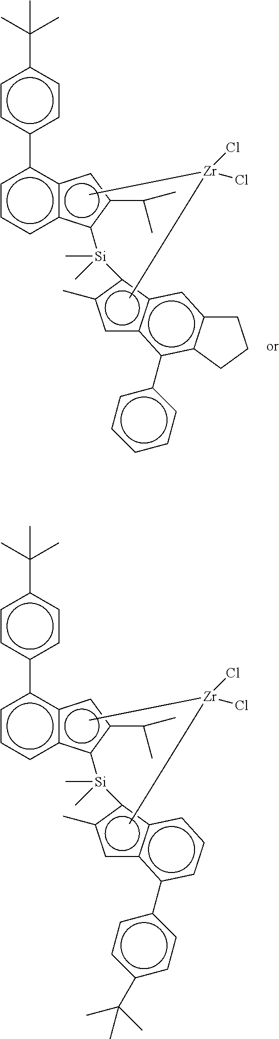
or the dimethyl analogs thereof.

22. A supported metallocene catalyst system produced by the process of claim 1, wherein the supported metallocene catalyst system has a catalyst productivity of greater than 50 gpolymer/g(cat)/hr.

23. The supported metallocene catalyst system of claim 22, wherein the catalyst system comprises from about 0.05 wt % to about 2.0 wt % group 4, 5, or 6 metal, based on the total weight of the catalyst system.

24. The supported metallocene catalyst system of claim 22, wherein the catalyst system comprises from about 0.02 to about 0.08 mmol of aluminum per gram of supported metallocene catalyst system.

25. The supported metallocene catalyst system of claim 22, wherein the catalyst system comprises about 0.04 mmol of aluminum per gram of supported metallocene catalyst system.

26. A supported metallocene catalyst system comprising:
(i) an alkyl aluminum treated support material;
wherein the alkyl aluminum treated support material is the reaction product of a support material and an alkyl aluminum;
wherein the support material is selected from the group consisting of SiO₂, Al₂O₃, or SiO₂/Al₂O₃; and
wherein the alkyl aluminum is represented by the formula:
R₃Al
wherein each R group is, independently, a substituted or unsubstituted C₁ to C₁₂ alkyl group, Cl or F with the proviso that at least one R group is a C₁ to C₁₂ alkyl group;
(ii) an ionic stoichiometric activator;
wherein the ionic stoichiometric activator is represented by the formula:
(Z)_{d}⁺A^{d-}
wherein (Z)_{d}⁺ is a cation, A^{d-} is a non-coordinating anion having the charge d−, and d is 1, 2, or 3, and (Z)_{d}⁺ is represented by the formula: (Ar₃C)⁺, where Ar is aryl or aryl substituted with a heteroatom, a C₁ to C₄₀ hydrocarbyl, or a substituted C₁ to C₄₀ hydrocarbyl; and
(iii) a metallocene compound represented by the formula: 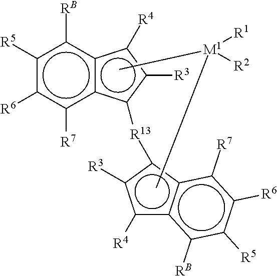
wherein:
M¹ is selected from titanium, zirconium, hafnium, vanadium, niobium, tantalum, chromium, molybdenum and tungsten;
R¹ and R² are selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and substituted or unsubstituted C₇ to C₄₀ arylalkenyl groups; optionally R¹ and R² are joined together to form a C₄ to C₄₀ alkanediyl group or a conjugated C₄ to C₄₀ diene ligand which is coordinated to M¹ in a metallacyclopentene fashion; optionally, R¹ and R² represent a conjugated diene, optionally, substituted with one or more groups independently selected from hydrocarbyl, trihydrocarbylsilyl, and trihydrocarbylsilylhydrocarbyl groups, said diene having a total of up to 40 atoms not counting hydrogen and forming a π complex with M¹;
each R³ and R^{B} is independently selected from hydrogen, halogen, substituted or unsubstituted C₁ to C₁₀ alkyl groups, substituted or unsubstituted C₆ to C₁₄ aryl groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups, substituted or unsubstituted C₈ to C₄₀ arylalkenyl groups, and —NR′₂, —SR′, —OR′, —SiR′₃, —OSiR′₃, and —PR′₂ radicals wherein each R′ is independently selected from halogen, substituted or unsubstituted C₁ to C₁₀ alkyl groups and substituted or unsubstituted C₆ to C₁₄ aryl groups;
R⁴, R⁵, R⁶, and R⁷ are each selected from the group consisting of hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and C₇ to C₄₀ substituted or unsubstituted arylalkenyl groups; and
R¹³ is selected from: 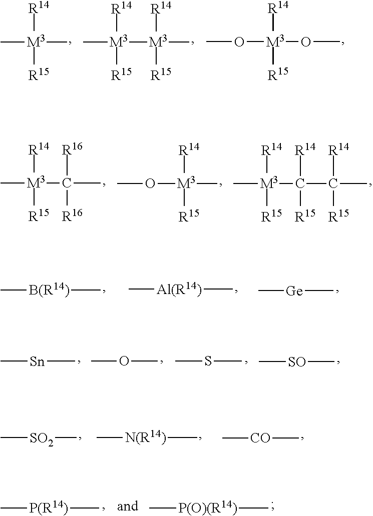
wherein:
R¹⁴, R¹⁵, and R¹⁶ are each independently selected from hydrogen, halogen, C₁ to C₂₀ alkyl groups, C₆ to C₃₀ aryl groups, C₁ to C₂₀ alkoxy groups, C₂ to C₂₀ alkenyl groups, C₇ to C₄₀ arylalkyl groups, C₈ to C₄₀ arylalkenyl groups and C₇ to C₄₀ alkylaryl groups, optionally R¹⁴ and R¹⁵, together with the atom(s) connecting them, form a ring; and
M³ is selected from carbon, silicon, germanium, and tin; or
R¹³ is represented by the formula: 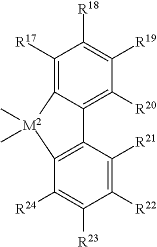
wherein:
R¹⁷, R¹⁸, R¹⁹, R²⁰, R²¹, R²², R²³, and R²⁴ are each independently selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ alkylaryl groups, substituted or unsubstituted C₇ to C₄₀ alkylaryl groups and substituted or unsubstituted C₈ to C₄₀ arylalkenyl groups; optionally, two or more adjacent radicals R¹⁷, R¹⁸, R¹⁹, R²⁰, R²¹, R²², R²³, and R²⁴, including R²⁰ and R²¹, together with the atoms connecting them, form one or more rings; and
M² represents one or more carbon atoms, or a silicon, germanium, or tin atom.

27. The supported metallocene catalyst system of claim 26, wherein the catalyst system comprises from about 0.05 wt % to about 2.0 wt % group 4, 5, or 6 metal, based on the total weight of the catalyst system.

28. The supported metallocene catalyst system of claim 26, wherein the catalyst system comprises from about 0.02 to about 0.08 mmol of aluminum per gram of supported metallocene catalyst system.

29. The supported metallocene catalyst system of claim 26, wherein the catalyst system comprises about 0.04 mmol of aluminum per gram of supported metallocene catalyst system.

30. A polymerization process comprising:
(i) contacting a support material with an alkyl aluminum compound to provide an alkyl aluminum treated support material, wherein the alkyl aluminum compound is represented by the formula:
R₃Al
wherein each R group is, independently, a substituted or unsubstituted C₁ to C₁₂ alkyl group, Cl or F, with the proviso that at least one R group is a C₁ to C₁₂ alkyl group;
(ii) contacting a metallocene compound comprising a group 4, 5, or 6 metal with the alkyl aluminum treated support material of step (i);
(iii) contacting an ionic stoichiometric activator with the alkyl aluminum treated support material of step (i);
wherein the ionic stoichiometric activator is represented by the formula:
(Z)_{d}⁺A^{d-}
wherein (Z)_{d}⁺ is a cation, A^{d-} is a non-coordinating anion having the charge d−, and d is 1, 2, or 3, and (Z)_{d}⁺ is represented by the formula: (Ar₃C)⁺, where Ar is aryl or aryl substituted with a heteroatom, a C₁ to C₄₀ hydrocarbyl, or a substituted C₁ to C₄₀ hydrocarbyl;
(iv) obtaining a supported metallocene catalyst system;
(v) contacting olefin comonomer with the supported metallocene catalyst system under polymerization conditions; and
(vi) obtaining a polyolefin.

31. The process of claim 30, wherein the metallocene compound is represented by the formula: 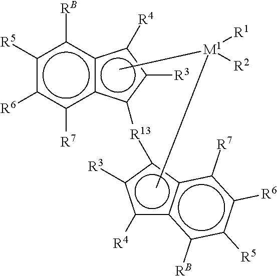
wherein:
M¹ is selected from titanium, zirconium, hafnium, vanadium, niobium, tantalum, chromium, molybdenum and tungsten;
R¹ and R² are selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and substituted or unsubstituted C₇ to C₄₀ arylalkenyl groups; optionally, R¹ and R² are joined together to form a C₄ to C₄₀ alkanediyl group or a conjugated C₄ to C₄₀ diene ligand which is coordinated to M¹ in a metallacyclopentene fashion; optionally, R¹ and R² represent a conjugated diene, optionally, substituted with one or more groups independently selected from hydrocarbyl, trihydrocarbylsilyl, and trihydrocarbylsilylhydrocarbyl groups, said diene having a total of up to 40 atoms not counting hydrogen and forming a π complex with M¹;
each R³ and R^{B} is independently selected from hydrogen, halogen, substituted or unsubstituted C₁ to C₁₀ alkyl groups, substituted or unsubstituted C₆ to C₁₄ aryl groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups, substituted or unsubstituted C₈ to C₄₀ arylalkenyl groups, and —NR′₂, —SR′, —OR′, —SiR′₃, —OSiR′₃, and —PR′₂ radicals wherein each R′ is independently selected from halogen, substituted or unsubstituted C₁ to C₁₀ alkyl groups and substituted or unsubstituted C₆ to C₁₄ aryl groups;
R⁴, R⁵, R⁶, and R⁷ are each selected from the group consisting of hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ arylalkyl groups, substituted or unsubstituted C₇ to C₄₀ alkylaryl groups and C₇ to C₄₀ substituted or unsubstituted arylalkenyl groups; and
R¹³ is selected from: 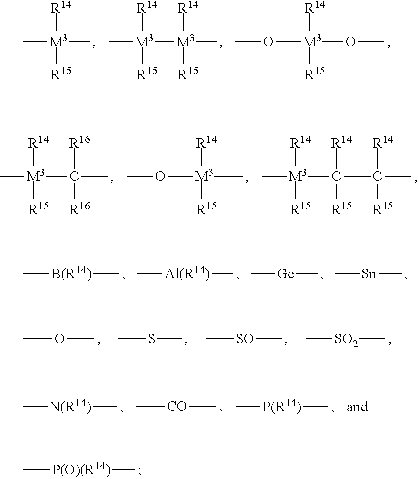
wherein:
R¹⁴, R¹⁵, and R¹⁶ are each independently selected from hydrogen, halogen, C₁ to C₂₀ alkyl groups, C₆ to C₃₀ aryl groups, C₁ to C₂₀ alkoxy groups, C₂ to C₂₀ alkenyl groups, C₇ to C₄₀ arylalkyl groups, C₈ to C₄₀ arylalkenyl groups and C₇ to C₄₀ alkylaryl groups, optionally R¹⁴ and R¹⁵, together with the atom(s) connecting them, form a ring; and
M³ is selected from carbon, silicon, germanium, and tin; or
R¹³ is represented by the formula: 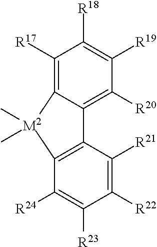
wherein:
R¹⁷, R¹⁸, R¹⁹, R²⁰, R²¹, R²², R²³, and R²⁴ are each independently selected from hydrogen, halogen, hydroxy, substituted or unsubstituted C₁ to C₁₀ alkyl groups, substituted or unsubstituted C₁ to C₁₀ alkoxy groups, substituted or unsubstituted C₆ to C₁₄ aryl groups, substituted or unsubstituted C₆ to C₁₄ aryloxy groups, substituted or unsubstituted C₂ to C₁₀ alkenyl groups, substituted or unsubstituted C₇ to C₄₀ alkylaryl groups, substituted or unsubstituted C₇ to C₄₀ alkylaryl groups and substituted or unsubstituted C₈ to C₄₀ arylalkenyl groups; optionally two or more adjacent radicals R¹⁷, R¹⁸, R¹⁹, R²⁰, R²¹, R²², R²³, and R²⁴, including R²⁰ and R²¹, together with the atoms connecting them, form one or more rings; and
M² represents one or more carbon atoms, or a silicon, germanium, or tin atom.

32. The process of claim 30, wherein the olefin monomers comprise propylene and/or ethylene.

33. The process of claim 30, wherein the supported metallocene catalyst system is contacted with propylene monomer to make polypropylene in a first stage.

34. The process of claim 33, further comprising contacting the polypropylene with the same or different supported metallocene catalyst system in the presence of ethylene to produce an impact copolymer in a second stage.

35. The process of claim 33, further comprising contacting the same or different supported metallocene catalyst system in the presence of ethylene and one or more C₃ to C₄₀ olefin monomers to produce an impact copolymer in a second stage.

36. A polypropylene made by the process of claim 30.
